(19) United States
(12) Patent Application Publication
(10) Pub. No.: US 2012/0030193 A1
(43) Pub. Date: Feb. 2, 2012

(54) Method and system for connecting users

(76) Inventors: Sagi Richberg, Ashland, MA (US); Sergey Gribov, Newton, MA (US)

(21) Appl. No.: 11/578,481

(22) PCT Filed: Apr. 14, 2005
(86) PCT No.: PCT/US05/12550

§ 371 Date: Aug. 9, 2011

Related U.S. Application Data
(60) Provisional application No. 60/561,947, filed on Apr. 14, 2004.

(51) Int. Cl. G06F 17/30

(52) U.S. Cl. 707/719

(57) ABSTRACT

A method and system for connecting users via a matrix/mesh/grid/graph of intermediate relationship routing (FIG. 3, element 50), comprising creating a collective business incentive awareness through a multi layered (per service) charge system defined by the users themselves, while utilizing and harnessing the power of P2P (Peer-to-Peer)/Client-Server, Collaboration tools, 3D/2D GUI (3d bubble/Birdseye view) navigation interfaces for effectively presenting a large volume of information to users. The system allows users(100,110) to focus on specific groups or individuals in a secure, private and anonymous environment.

### BACKGROUND OF THE INVENTION

### Field of the Invention

The present invention relates generally to online monetary driven social networking systems and methods and, more specifically, to a multi option charge per service offered by the social networking system members utilizing and leveraging their social capital. The invention pertains more particularly to methods for optimizing and enhancing the social networking experience for users by enabling/creating and/or improving three main elements (factors): Business/Financial model (Multi level incentive based), the user interface (Presentation-GUI 3D/2D real time interface) and System Security (Anonymity, privacy, validation and authentication).

### BACKGROUND

The following references are believed to be relevant to the present invention.

| | | |
|---|---|---|
| 6,175,831 | January 2001 | Weinreich et al. |
| WO05006152A2 | January 2005 | ABRAMS et al. |
| US20050021750A1 | January 2005 | ABRAMS et al. |
| US1999000134018P | May 1999 | COLONNA et al. |
| US2000000569808 | May 2000 | COLONNA et al. |
| US2003000487191P | July 2003 | BIRNBAUM et al. |
| EP1065607A3 | May 2002 | Glance et al. |
| EP1288795A1 | March 2003 | Norman et al. |
| JP2002132604A2 | May 2002 | BINSTED et al. |
| US20030050977A1 | May 2003 | Puthenkulam et al. |
| US2003000649149 | May 2005 | Solari et al. |
| US2004000803744 | March 2003 | Burne et al. |
| US2003000455998P | March 2003 | Burne et al. |
| US2002000080878 | August 2002 | Trevithick et al. |
| US2002000323568 | June 2004 | Dom et al. |
| US20040148275A1 | July 2004 | Achlioptas et al. |
| 6745178 | June 2001 | Emens et al. |

Six Degrees of Separation: by Duncan J. Watts ISBN 0-393-04142-5
Albert-Laszlo Barabasi: ISBN 0-7382-0667-9
Mark Buchanan: ISBN 0-393-04153-0
http://www.corante.com/many/: MANY 2 MANY
www.thevirtualhandshake: David TETEN
http://socialsoftware.weblogsinc.com/entry/7302077097686276/

### BRIEF DESCRIPTION OF THE FIGURES

The present invention may be understood by reference to the following detailed description of the preferred embodiment of the present invention and the appended figures:

FIG. 1 Is a basic overview of the six degrees of separation concept where an individual (Source) utilizes the services of an intermediary (3^{rd} party) in order to reach another (Destination) user.

FIG. 2 Is an illustration of the three approaches employed by the system: Distributed, Peer-To-Peer and a mixture of the two in order to reduce overhead on system servers and to reduce bandwidth consumption.

FIG. 3 Is an overview diagram of an embodiment of the system and infrastructure according to an embodiment of the invention with emphasis on the underlying hardware infrastructure and server side.

FIG. 4 Is an overview of the infrastructure with an emphasis on the clients applications (Software) and GUI (Graphics User Interface).

FIG. 5 Is an explanation of the use of encryption and security mechanisms such as: PKI, SSL, SET, KERBEROS in order to keep the privacy of its clients.

FIG. 6 Is an overview of one implementation that provides virtual communication services over real world switched phone system (PSTN) and using an encapsulation method via an IVR system in order to protect users privacy when offering phone communication services.

FIG. 7 Presents the initial process of a user opening an account and registering with the system database.

FIG. 8 Describes the input a user has to provide in order to set up the service in regards to charging a fee per connection method and the catalog/book of system suggestions on how much should one charge for service based on real life tangible data and statistics gathered by the system activity metrics.

FIG. 9 Presents additional input info that the user is providing and the basics of what the user has to offer and what he is seeking.

FIG. 10 Is an illustration of the complex search mechanisms and metrics used by the system to reducing the “path cost.”

FIG. 11 Is an illustration of a dating service search mechanism where pieces of face images are used and combined with AI algorithms in order to find a visual match in the system database for an individual looking for a date.

FIG. 12 Describes one of the 3D real time interactive GUI's emphasizing Link Strength, Link relationships based on color, thickness of the “spline” and the numbering system that connects individuals together. It also provides information about group memberships and interests represented by the “Flower” and “Duck”. FIG. 12 also features the menu system that is invoked by right-clicking the picture and the fading effect of pictures that are family related which helps with information overload by reducing the amount of pictures at any given time.

FIG. 13 Describes the menu that provides information about the fee required in order to contact a prospect. It also emphasizes that in this case CHAT will cost $500 and that the user name is NOT real but an encapsulation is presented by an alias valid only for one paid session.

FIG. 14 Describes the procedure used in order to encapsulate the real persons chat nickname and representing to the individual who initiated the query a ransom nick name valid only for that session. The system server is acting as a relay for all communication needs, thereby hiding users' true identities by default unless chosen otherwise by the users themselves.

FIG. 15 Describes Multiple sub menus such as administrative tasks (Reporting, Getting verified, Rating, Arbitrating and Blessing) and peer to peer options such as File Sharing, and distributed computing.

FIG. 16 Describes Multiple sub menus such as additional search mechanisms and algorithms.

FIG. 17 Describes the encapsulation of the E-Mail address service similarly to the chat process relayed via the system server running an SMTP service.

FIG. 18 illustrates the trading menu.

FIG. 19 Describes the trading and file sharing mechanism.

FIG. 20 Describes the ratio trading component that allows a user to swap a file or service for a pre defined ration, Also described is the Lottery service that allows a user to set up a “Lottery” system so that users that are seeking for his/her services will benefit from free services from time to time. This helps increase traffic for the user who initiated the service.

FIG. 21 Describes a novel method of creating a virtual service offering on the fly in real time associated or non associated with a fee and the ability to auction the service to the highest bidder.

FIG. 22 Describes the auction part of the of what was described in FIG. 21 in further detail.

FIG. 23 Describes a method of setting a “Proxy” (The “P” Icon on top of the user's picture) which is the ability of an individual to delegate total responsibility and empower another user to represent him. This is best suited for instances where a user will not be available for a long time or if his/her queue is full and they do not want to turn don users.

FIG. 24 Describes Multiple user interfaces presentation and views (2D, 3D, Name only, Images).

FIG. 25 is an illustration of sub menus of scheduling a service contact in case destination user is NOT available and creating a virtual queue.

FIG. 26 Describes in further detail the process of scheduling as illustrated in FIG. 25 where an individual can charge different prices for different dates/times.

FIG. 27 Describes the secure payment via Pay Pal or any other encrypted commercial service and also the ability to set up a “Group” rate in case several people who know one another are interested in contacting the same individual for a reduced price.

FIG. 28 Describes a method of a user claiming to know another user and supplying information which in turn is saved in the database module for various metrics (Relationship Strength, Response time, Methods of reach) which enhance the reduction of path cost.

FIG. 29 Describes a real-time monitor (Sonar) showing the history of source people who were looking for a destination individual and passed through the user. Also described is the ability to set up an “Agent” based on different metrics criteria (Price per service, Link Strength etc.).

FIG. 30 Describes a method where a user can cut and past HTML code and create a Home Page on-the-fly in real-time including meta data for indexing.

FIG. 31 Describes a method of utilizing a “Proximity Monitor” where geographically self aware devices (Hot Spots, Wireless, Cellular Towers) are used as metrics that provide information about ones location (Longitude, Altitude) combines with ones preferences that were previously defined by the user and stored in the database module in order to match and report physical proximity of users with similar interests

FIG. 32 Presents another world view GUI

FIG. 33 Describes the ability to control 6 degrees of motion and the ability to rotate the “World” and it's contents “links” in side it and “Zoom” in and out to find links

FIG. 34 Presents the overwhelming of information when fully zoomed out of the “World/Universe”

FIG. 35 Presents a parabolic/Birdseye view of links

FIG. 36 Presents a 2D view with a users personal information tag

FIG. 37 Is a menu describing exchange and synchronization of destination users info.

FIG. 38 Illustrates an individual's interests tag

FIG. 39. Illustrates an E-Mail windows once payment was received

FIG. 40 Describes a method of visually representing a free virtual world with area of hierarchical representation (Microsoft). Also represented is a method of illustrating and individual busy in a transaction represented by an animation of colored lines (Amiram and Sandy). FIG. 40. Also presents a green link between users with arrows on both sides which represent how well a user claims to know the destination user and the other arrow represents what the destination user really thinks about the contact strength (Another metric for users to consider before paying money to an individual who claims to now a destination user). A Filtering mechanism exists in FIG. 40 that enables an individual to see only the degrees of separation he or she is interested in or users belonging to a specific group.

FIG. 41 Describes a method that enables users to see if other users are currently surfing the same website with their browser. When users connect to the same website and the service is enabled a flashing ICON “W” will appear on the map indicating that they are currently on the same URL. This is significant, if for example, people who surf the same website are likely to have something in common. It may also provide an indication of such a case to enhance the interaction experience and brings individuals one step closer without exhausting resources.

FIG. 42 Again Illustrates concurrent URL access by multiple users but this time with a list box created on the 3d map

FIG. 43 Is a method of utilizing the system database for entertainment and games creation. Games engines can utilize Pictures, Sounds and even metrics available from the system to create fun and engaging games. Illustrated here is a “Space Invaders” game based on peoples pictures. Games can be 2D or 3D and the system provides a platform for development.

FIG. 44-50 depict a method of creating a group for collaboration and mutual benefit and enabling that group only to its members.

FIG. 51 represents but is not limited to the different variables in the database that enable the complex computations in order to reduce the path's cost and advanced search abilities.

FIG. 52-57 are flow charts of particular phases of operation of the present invention.

FIG. 58 Is a scenario describing the concept of six degrees of separation and the small world theory, logging on to the system, introduction to the concepts of non verifies users, family relation, Blessed attribute and relationship strengths in general

FIG. 59 Is a scenario explaining the search feature, pay per service, hops, merchant payments, path selection and VShakes commission from transaction

FIG. 60 Describes the use of a proxy is order to mask the real phone number of a user in Vshakes social network

FIG. 61 Describes the process of being verified, blessed and path selection

FIG. 62 Is an illustration of the 3D gui which is comprised of polygons representing people with their respective picture on top, spline/bezier curves connecting the polygons and representing relation strengths respectively by color and width, relation strength number and peoples names on the bottom of the polygon

FIG. 63 Is a closer look at the 3D space where 3D depth can be observed (Z axis) while some polygons are at the back of one another, also varying widths of Bezier curves are presented.

FIG. 64. Is an illustration of the dotted 3D Bezier curve representing a non verified user attribute and a “Blessed” icon designation is presented on top of the far left polygon. An arrow presents the direction of the origin of relationship claim.

FIG. 65. Is an illustration of a verified person by designating a “V” icon on the polygons chest.

FIG. 66. Represents a “Super Conductor/Information Broker” which is an attribute given to a user who is very well connected (possesses multiple links)

FIG. 67 Illustrates a bi-directional relationship claim represented by 2 arrows indicating the direction of the origin of the claim with a number of top of the arrow representing the strength of the relationship claim

FIG. 68. Is a closer look at a uni directional claim ending at the Bezier curve with an arrow indicating the relationship claim originated from user brian (polygon on the right)

FIG. 69 represents VShakes authentication and validation API. It is a mechanism to enhance and complement the security of 3^{rd} party merchants by enabling them to connect to Shakes DB via an API in order to verify a users validity.

FIG. 70. Is an illustration of VShakes unique user validation technique by employing a real world ID verification at a mail carrier center by sending a unique number via physical mail that requires a person to pick the mail at a post office/carriers office and present a personal ID/Drivers license card.

FIG. 71 Is an illustration of a 2D generated coinpany organization chart view, where a user is connecting to strong links via its right hand, to weak links via its left hand and to a company/companies he works for or know people at via it's legs.

FIG. 72. Is an illustration of the 3D GUI at search execution represented by a sequence of frames (animation) where is order to reduce the amount of overwhelming information we employ a distortion combines with spheres instead of polygons in order to speed rendering times and preserve screen real estate area.

FIG. 73 Is a sequence of frames representing a 3D orgcahrt generation and view where a user connected to a company via a Bezier curve and the company tree/hierarchy expands or collapses based on the users action (Doubke Click on the branch/leaf expands and the opposite collapses/shrinks)

FIG. 74. Is another sequence of frames and animation representing a fly-through (Search) where we employ a distortion technique.

FIG. 75 Is a sequence of frames representing the flythrough in 3D space (X,Y,Z coordinate system) and collapse/expand of user polygons represented by spheres

FIG. 76. Is an illustration of the private groups feature in VShake where a group of people can band together and designate a “gate keeper” which acts as a filter to the group.

FIG. 77. Is an illustration of a true targeted advertising in VShakes network, the advertising is executed under or above very well connected individuals (Super Conductors/Information Brokers) and/or at search time when screen real estate is more available and flythrough advertisements are zoomed into at search time.

FIG. 78 Is an illustration of a geographical view in Shakes network where a user of the system can choose a view that lets him/her trace what country's are other interconnected users are from and help identify people from the same area.

FIG. 79 is a legend for interpretation of flow chart symbols used herein.

### DETAILED DESCRIPTION OF THE PREFERRED EMBODIMENT

There is a current opportunity in the business world to network people by utilizing the power of intermediate digital introduction technologies and harnessing the powers of Peer To Peer networks and Collaboration tools, and accomplish this goal under guaranteed privacy and anonymity. The invention replaces or augments obsolete social and business networking such as: Physical people networking meetings (Dating), Business Cards, Lead Generation tools

(Databases), Marketing initiatives and all other activities relating and leading to business/revenue generation or any other benefit resulting form diverse needs. The invention also assists job seekers, Marketing personnel, Business decision makers or anyone with a motive to receive compensation for goods offered (Virtual or Tangible). The invention creates an infrastructure and an incentive for individuals to contact others due to a need for business, companionship, products or any other offerings one might desire by protecting ones identity (E-mail, Phone, Chat Nick Name, Web Cam etc) and personal information, The invention achieves this goal by letting the users set their own price for any individual contact method (E-Mail, Phone, Chat, VOIP etc) thus setting a barrier for spammers or any other individuals engaging in non productive, identity theft and/or other non-business oriented activities. Another added value of the invention is reaching a targeted individual via someone else who claims to know the targeted individual (Destination) and discovering unknown paths to that target, The invention introduces tree types of users:
1. A “Verified” user where due diligence and a background check was performed by a system NOC(Network Operation Center)/Operators Support Stuff/Help Desk which includes but is not limited to the following: Credit Card Check, D&B lookup, Company employment and Home address authentication for an extra fee. This ensures reasonable credibility because the system administrator? or operator is willing to act as arbitrator in case of disputed transactions.
2. A “Blessed” user where extra security ensures that this user is indeed related or knows the target user as claimed by his profile in our database (A verified user can become blessed via another verified user). This ensures appropriate credibility and transactions are insured by the system administrator?—Money back guaranteed.
3. Regular “R”—A user who is not verified nor blessed—in one embodiment, the system administrator/Operator takes no responsibility for users willing to pay for contact.

In one embodiment, the invention introduces unique visualization interface for navigation that reduce the overwhelming of link information between people thus isolating areas of interest based on smart search criteria and image manipulation and distortion. This technology provides the ability to represent virtual relation links based on layers/levels of: Geography, Hierarchy (Company's food chain), Logical or random. Search capabilities can include but not be limited to the following: Name, E-Mail, Geographical/Virtual location, Metrics (Relationships strengths—How well does an individual claim to know the target [1 being strongest to 5 being weakest]), Number of “hops” to target (Similar to internet routers), Charge amount etc.

In one embodiment, the invention enables individuals or groups, providing a discounted rate for conference as an example, the ability to find and contact other members, individuals or organizations who are connected simultaneously to the same website.

In one embodiment, the invention supports file sharing (Also ratio swapping) and distributed computing for remote resource utilization (CPU, RAM etc.) and auctions on-the-fly.

The method and system can provide at least 2 methods of user connections:
1. A downloadable client based on an executable i.e.: Java, VB, C++, or similar.
2. A web service (Portal) in order to resolve potential problems such as firewalls, Network address translations or cross platform issues that might impair system functionality. i.e.: Flash, Director 3D

The method and system can include 3 main components:
1. Server: Portal: Database Registration, IVR?, Home Pages, Search Engine, Secure filtering and authentication mechanisms
2. Client: (Java or .Net)—Applications: Chat, Phone, Fax, SMS, E-mail, VOIP, Webcam
3. 3D/2D intuitive space navigation/visualization and information focusing GUI

The system and method can support the creation of personal homepages, Picture, Sound and Icon uploading and any other form of personal profile creation.

In one embodiment, the invention financial model can include multiple layers, for example:
1. Free profile creation, Search and contact mechanisms (Unless target user defines charges for contact, goods or service)
2. Registered Users who become “Verified” after due diligence by the system administrator/Operator/.

In one embodiment, the invention connects to payment mechanisms such as Paypal, Credit Card companies (Visa, Master Card, American Express etc) to enable users to pay electronically and securely for both monthly/yearly due diligence/membership charges and also the target user providing the “goods” per service and commissions to the system administrator.

In one embodiment, the invention is providing all services under strict security by making sure all traffic and collaboration (E-mail, Chat, Webcam etc) is routed via the system administrator's/Operators secure servers. Further, contact information is given on a per session basis which means that all contact information is encapsulated and can only be used once per session per payment.

In one embodiment, the invention will revolutionize the market by propelling business networking and creating a world grid and collective of joint effort collaboration, thus reducing the time and cost of lead generation and networking.

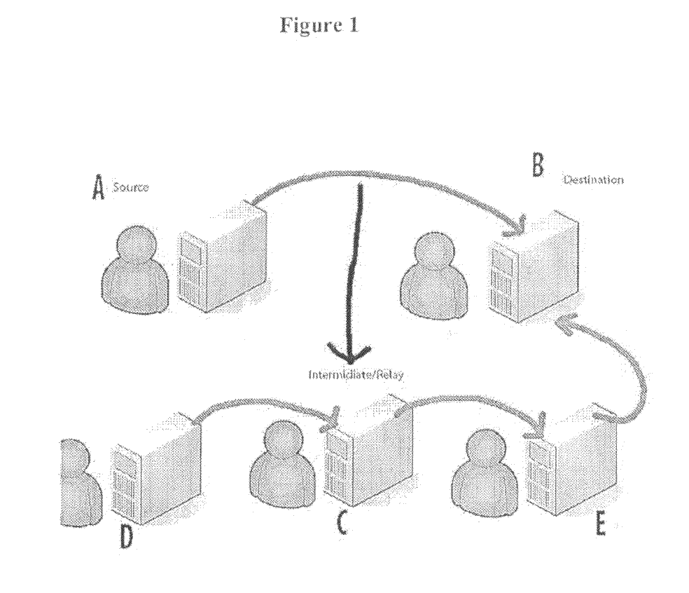

Referring to FIG. 1, a method of reaching a destination is presented via intermediaries also known as relays. User1 (Source) wants to reach User2 (Destination) and discovers a path of relays which can assist him in doing so by introduction which is by default associated with a fee presented by the relay. There is a high probability that an intermediate will charge a reduced fee in order to introduce the Source with the Destination relative to the cost for the Source to directly contact the Destination user. The concept is to reach the Destination via the “BEST” path which translates in this case to lowest cost, strongest relationship, reliability, performance and other metrics used to measure the effectiveness of the path or relay chosen. These factors can be custom weighed by the source user.

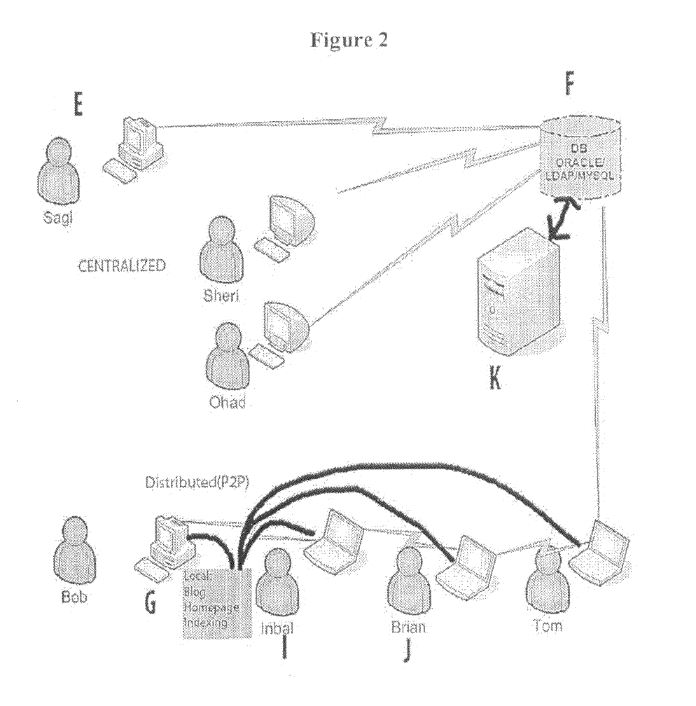

Referring to FIG. 2, There are at least 3 methods of operation in the system: a. Centralized (Default)—Where users are setting prices for different vehicles of communication and utilizing the system server and database module as a security, filter, search and billing mechanism

b. Peer-to-peer, Where users are using their own computers with mini databases, indexing and Meta searches capabilities where no security, filtering or billing mechanism is enforced
c. Blended mode, where the system server provides all of the above mentioned in section “a.” but local computers are used mainly for local databases and indexing services for bloging, website (Homepage) and user search in case the system server is out of operation.

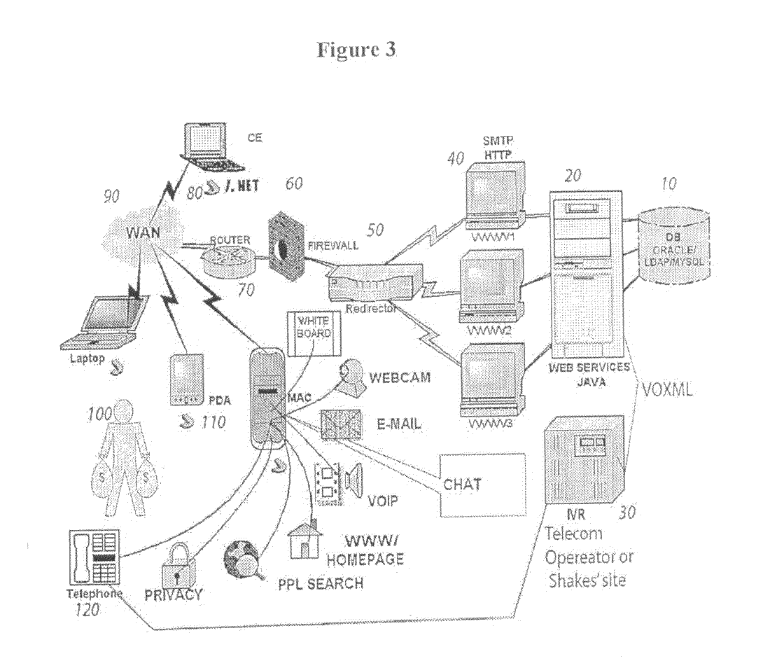

Referring to FIG. 3, In the backend is a database module (10) which hold all of the users, relations and other metrics discussed in further detail later, comprised of RDBMS databases but preferably OBJECT oriented (e.g., Jasmin by CA). Host server (20) is where all users transactions take place and the plurality of front end web servers provide for a portal point (HTTP server), Mail server (SMTP) and enable load balancing in cases of high users volume and traffic which is redirected to them by a front load balancer/redirector(50).

The server(20) and DB(10) are connected to a local IVR/VOIP machine(30) which in turn is connected to a PBX system/VOIP NETWORKS and the global PSTN.

The redirector(50) is connected to a firewall(60) Which prevents unlawful access to the system server and database module. The firewall is connected to a router (70) that connects to the WAN(90) that reaches the system's client software and users.

A client (80) in this case a windows CE system downloads a java client or utilizes a web browser (Internet Explorer, Netscape, Opera etc) in order to interact with the server and database module.

This approach is very portable due to the use of the java language and for that reason we illustrate a windows CE client(80) a PDA(110) and laptop clients that are able to run the service.

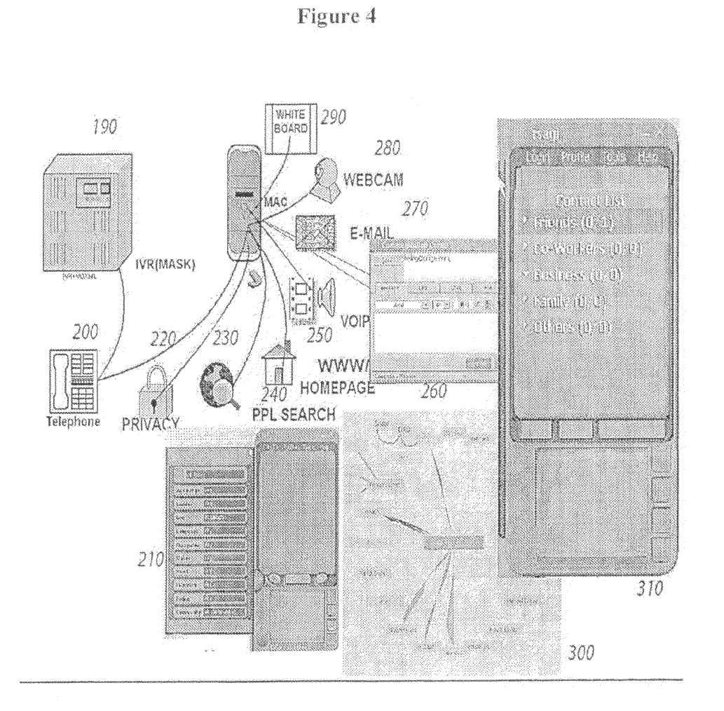

A user(100) creates an account with the system and information associated with the user is stored in the database module. The user inputs information and uses the multiple services described in FIG. 4 in order to find a destination user or provide his own services acting as a destination or relay user himself and charging for various services described in FIG. 4. Windows based systems (80) are also supported via a .NET downloadable client.

Referring to FIG. 4 the client computer (Macintosh®) is connected to the internet and the server and database. A user is able to contact other users or be contacted him self via the following communication and collaboration tools: Phone(200) to use the PSTN in order to talk to another user, search engine(230) in order to locate other users or be located by other, Homepage(240) for users to convey and present information about themselves, VOIP(250) for utilizing IP networks for voice over IP communication, Chat(260) with other users, E-mail(270) for sending and receiving E-mails, Webcam(280) for video conferencing and Whiteboard in order to participate in groupware activity (Share pictures/bitmaps and draw in real time).

The 2D map (300) is presented and populated with users including splines (flexible connections between users/nodes that can be manipulated in 3D space) in different colors representing various link strengths and an online presence application (310) for instant messaging.

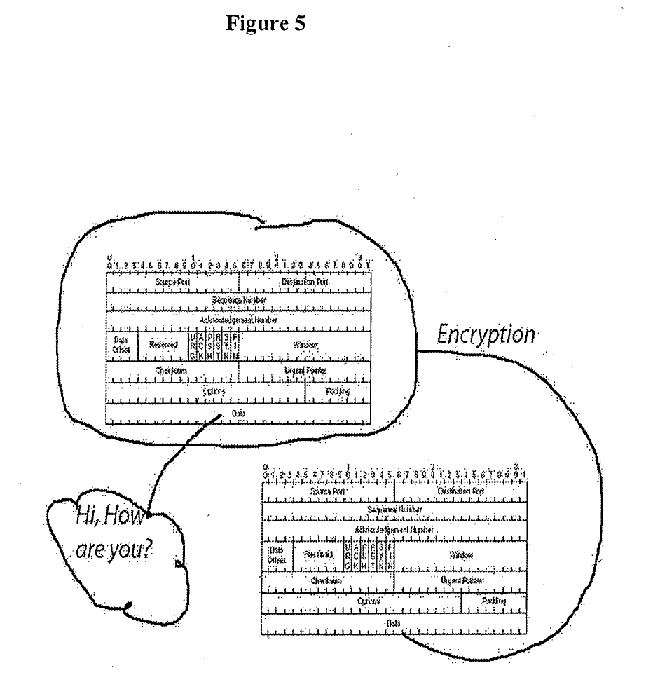

Referring to FIG. 5, a means of encrypting the data transferred (Email, Chat, VOIP) is presented where the TCP packet's data field is ciphered utilizing known secure algorithms and key management schemes such as: MD5, KERBEROS, PKI etc.

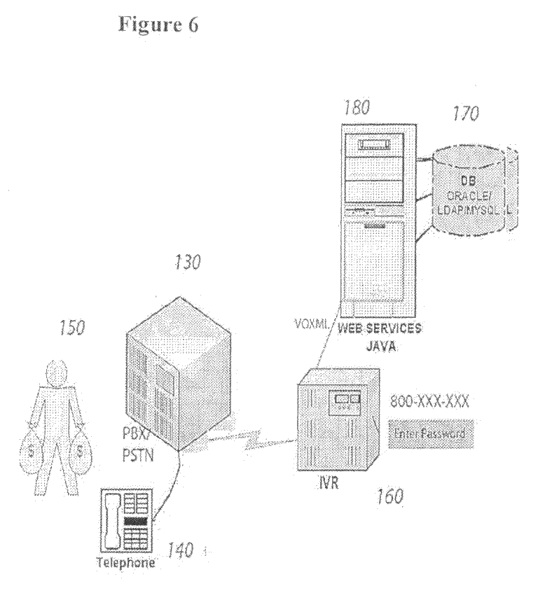

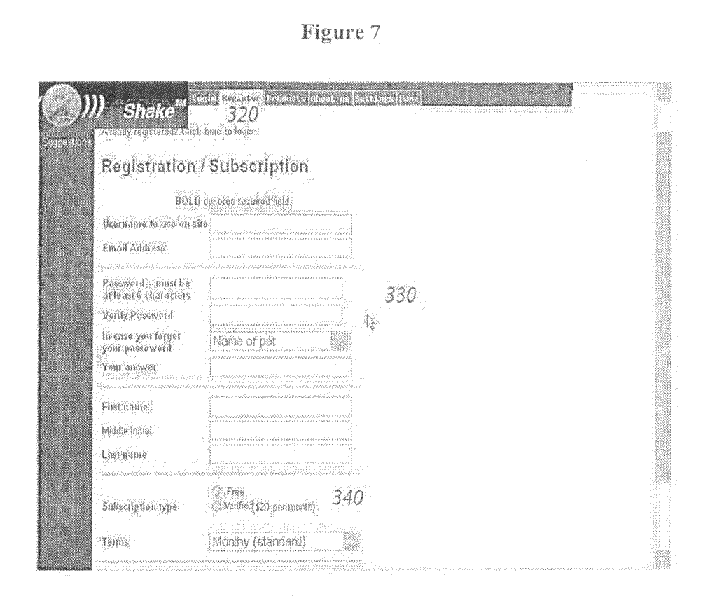

Referring to FIG. 6, a novel method of a user connecting to a destination or a relay user via a regular telephone (PSTN) while never knowing the users real phone number and the connection being in effect only for that session which the source user has paid for. Source user (150) has searched the database module for a destination user which was found and presented various communication methods (E-mail, Fax, Chat, VOIP, Webcam etc) for different prices, Source user (150) chose the phone option (140) and after payment to a 3^{rd} party (Credit card processor, Paypal etc.) was given a 1-800 number to call, Source user (150) picks up the phone and calls the 1-800 number which is routed via a PBX(13) and reaches the IVR machine (160)/VOIP which is connected to server (180). Database module (170) generated an ID variable which is used for a one time session as a password utilized by the IVR box (160) as the question being prompted to the user when he calls. Only after the user supplies the password will the IVR establish the conversation between Source user (150) and the destination user. When the call terminates the database (170) is notified and a new random ID number is being generated discarding the old one. If source user (150) try's to contact the destination user again without paying (Assuming he was not provided with destinations real phone number by the destination disclosing it) he or she will not be successful.

Referring to FIG. 7, illustrated is the screen where the user has to provide account information (User Name, Password, Fee) that is populating the tables and records in the database.

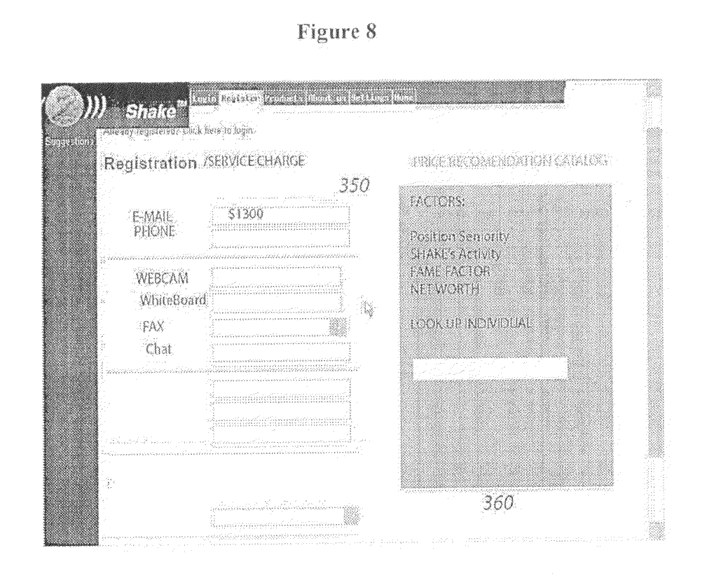

Referring to FIG. 8, The user has to provide information about the fee he or she is interested in charging per service(350)—(Email, Chat, Phone, Fax, Webcam, Whiteboard, Voip etc.). Also provided is a guidance book (360) on “How much should one charge” based on historical statistical data gathered based on metrics such as: individuals seniority in a corporation, the user's system, activity, Frame factor, Net Worth, Super Conductor, Verified, Ratings, Blessed, Relation Strengths and other metrics describes later on.

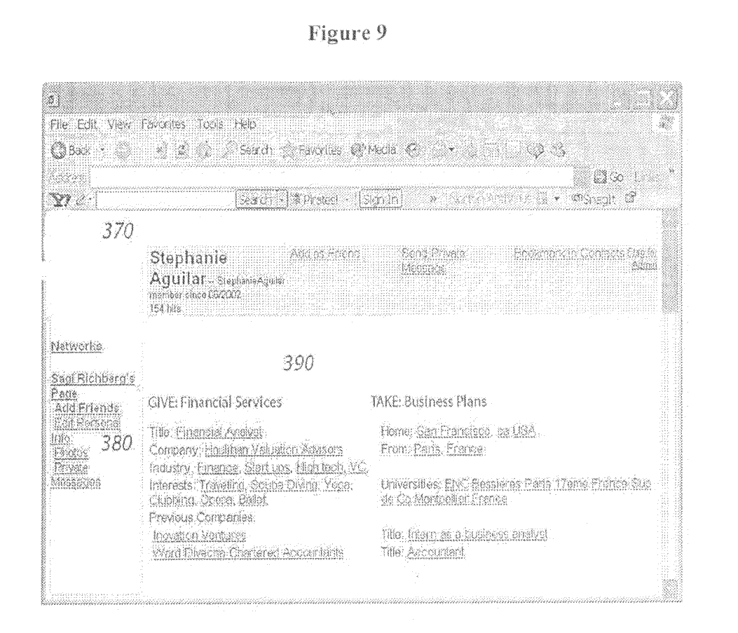

Referring to FIG. 9, here are additional parameters (390) provided by the user to create a profile later used by other users in the search and query process with specific emphasis on 2 fields: 1. GIVE: this is where the user supplies information about what he has to offer for a fee or for free is this case financial consulting
3. Take: Defining in the database what he or she needs from a destination or relay user in this case needing a business plan. This type of field allows for multiple data separated by a comma i.e.: Movies, Games, Sports which acts as meta and is indexed so when a user runs a logic query (Movies AND Games OR Sports) he will reach this user.

General data input is also supplied in this section: Location (Country, City, Region), Academicals, titles, industry and so forth.

Additional info (380) such as uploading of photo's, profile editing and networks belonging to is provided.

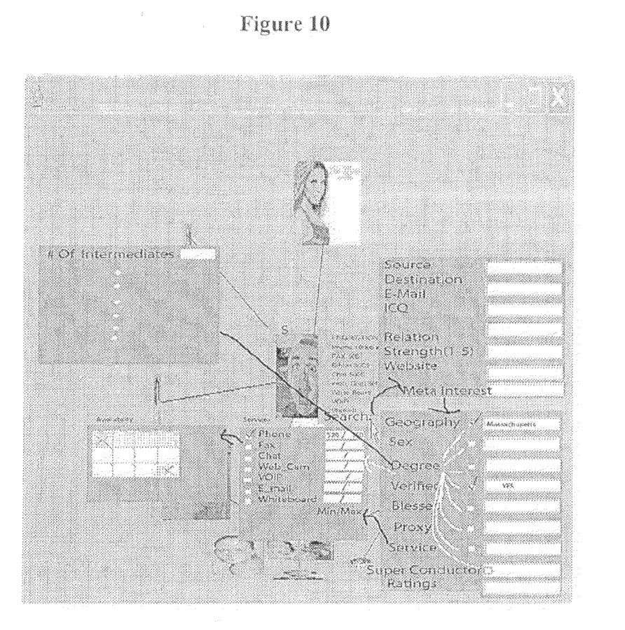

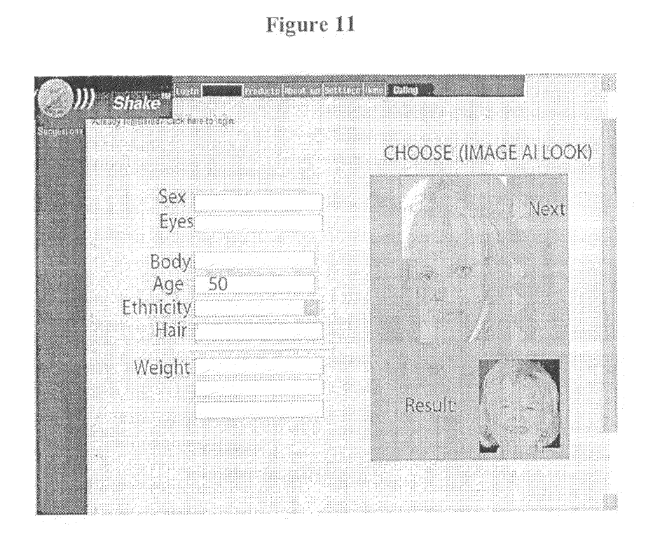

Referring to FIG. 10, after supplying with the account and personal information and defining the needs and offers, the user is introduced to the 2D map where pictures of individuals with links between them exist.

Right Clicking a user's picture or name invokes a menu that describes the numerous offerings of services and their associated fees (More on that later). Choosing the SEARCH Options open up a plethora of additional windows (5) Menu's+Sub Menu's and presents a rich search mechanism.

In the first windows the user has to provide the Source and Destination (Name, Family Name) information, the user can also search based on a users E-mail address, relationship strengths, website address or meta search variables that have been pre defined by the potential users.

Location, Gender and other advanced searches are available such as a search based on a single communication offering (In this case the Phone service) or even based on a per service price ($20/$50) and it's calendar availability (hh/dd/mm/yy).

Another advanced search option is to find people based on the relativity to others based on the degree of separation formula (1-6) from others.

Referring to FIG. 11, presented is a multimedia search mechanism where a user defines parameters such as: Gender, Eye color, Body Style, Age etc. AND/OR scrolls slides of parts of a head made from multiple face photo pieces that once placed to the users satisfaction and the search is executed an AI algorithm combined with morphing, pattern recognition and edge detection techniques are used to find a match for dating proposes.

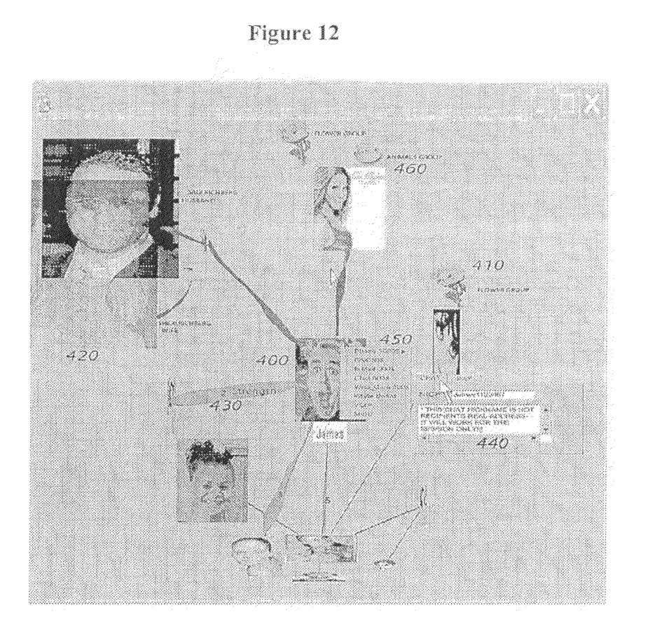

Referring to FIG. 12, presented is the 2D map with pictures of destination or relay users that were searched by the source user. Icons (460) above the pictures represent belonging to Interest Groups pre-defined (Discussed Later) which provides another layer of intuitive visual information about an individual and his/her interests (Animal Group/Flower group—it makes it easier to remember an Icon than a name and while one wonders in the space of relationships he/she might focus on a known ICON in the sea of users/nodes).

Relationships (430) are represented by colored links/lines/splines representing relationship strengths (1 strongest-5 weakest) and also by thickness (The thicker/bolder/brighter the better the relationship is).

The pictures on the upper left (420) with red color links are family ties (Blood ties) thus family members will appear translucently on top of one another to save space, reduce information overload and distinguish family ties from other links.

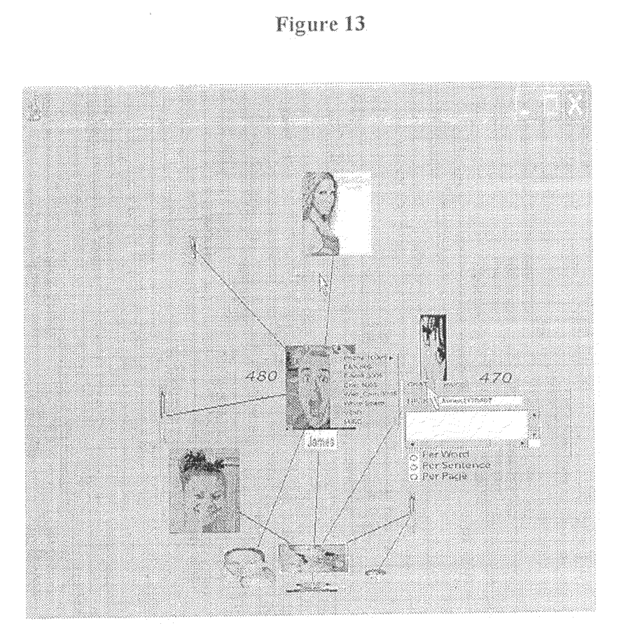

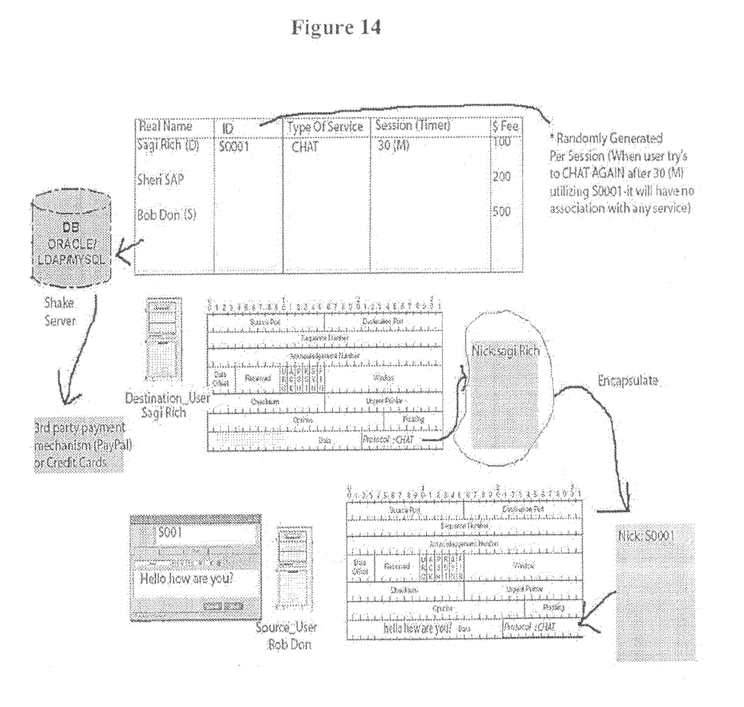

Referring to FIG. 13, represents a chat session (470) initiated with a user (480). The Chat service itself is comprised out of several charge mechanisms (Per Word, Per Sentence, per Page or free write per session) in this case $500. Emphasis on the nickname which is again an encapsulated one (Not a real chat name. Created just per session) that prevents malicious users from abusing the privacy and economy of a charging user (the encapsulation method is discussed in further detail in FIG. 14).

Referring to FIG. 14, is a method of converting (encapsulating) a nick name in a messaging program (Chat) to a fake user ID created only for that session. Presented is a source user (Bob Don) connecting to a destination user (Sagi Rich) via a chat program session after paying a fee ($100). The upper figure is a TCP packet using a chat protocol that uses the database module and retrieves an ID (S0001) which is valid for 30 Minutes (Indicated in the database) and encapsulates the real nickname (Sagi Rich) to S0001 for the sessions duration which after the ID is purged from the database. Source user (Bob Don) chats with destination user (Sagi Rich) knowing him as S001 in his chat program (Bottom left figure) and the users privacy is kept.

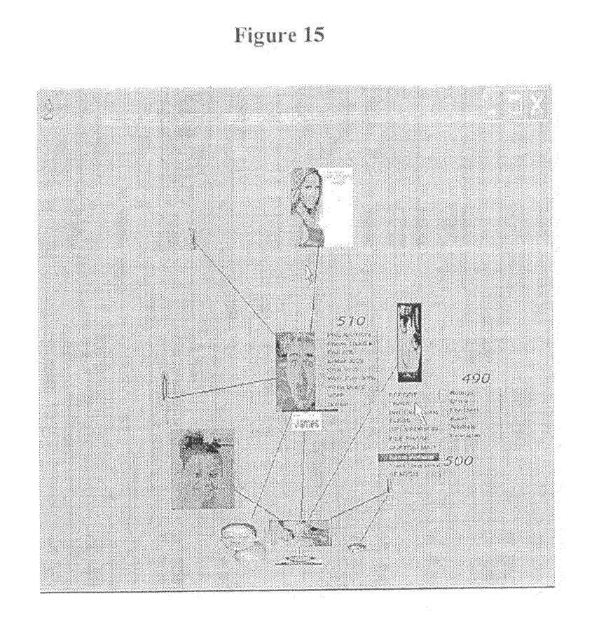

Referring to FIG. 15, right clicking user James (510) invokes a menu and a submenu under “Report”(490), Several options are available: Ratings (Presents the rating this user was given by other from a history of transactions), Crime (Takes the user to an HTML page to report malicious problems), Feedback (Takes user to HTML to leave feedback about James), Spam (Reporting spam), Arbitrate (In case of a transaction gone bad, a system administrator will try and arbitrate between the parties), Insurance (Become a verified user which enables a money back guaranteed if transaction gone bad ONLY with another verified user).

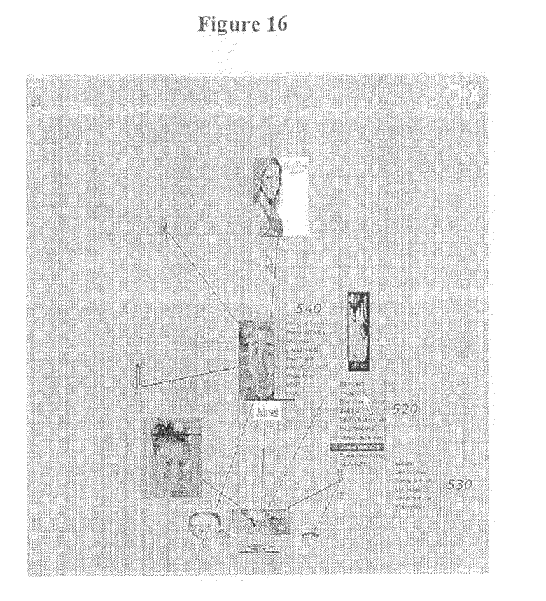

Referring to FIG. 16, presents another way (530) to search quickly for destination and relay users

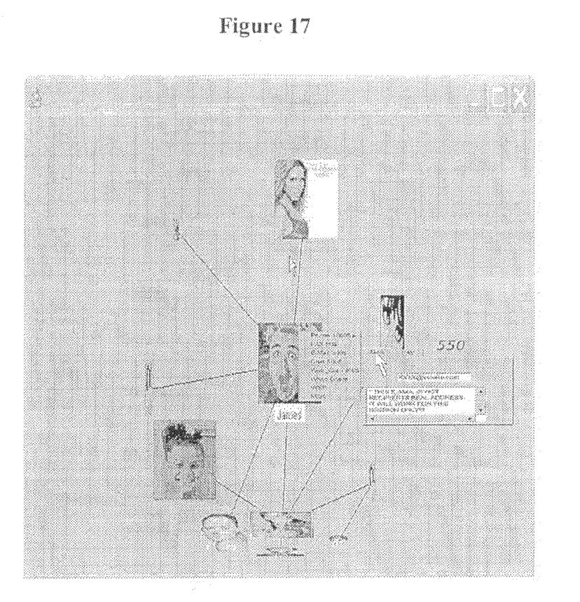

Referring to FIG. 17, is a method similar to the one presented in FIG. 14 where a user that decided to pay ($300) for an E-mail sending service (550) is provided with a non-real E-mail address (XXXX@vshake.com) which is an encapsulation to the SMTP protocol's data field done by the system's SMTP server service.

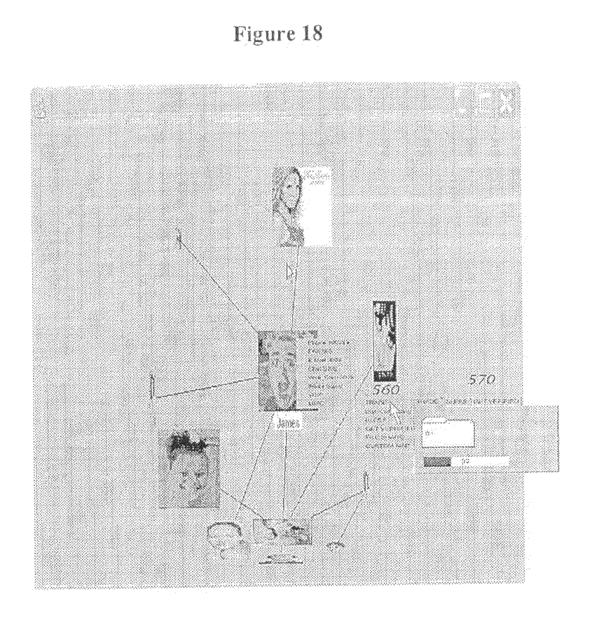

Referring to FIG. 18, is a method of trading (570) services or files with the ability to apply ratio and fees. Also available option on the upper menu (560) is the support for future distributed computing where an ID is generated in the database with host hardware and software information (IP number, CPU type, Memory, Storage capacity) so when a remote execution and distribution aware software is installed initialized and recognized it will have the ability to use remote users resources for a fee or for free.

The custom map option let users apply filters and save custom maps (i.e.: A user wants to see only people who are verified).

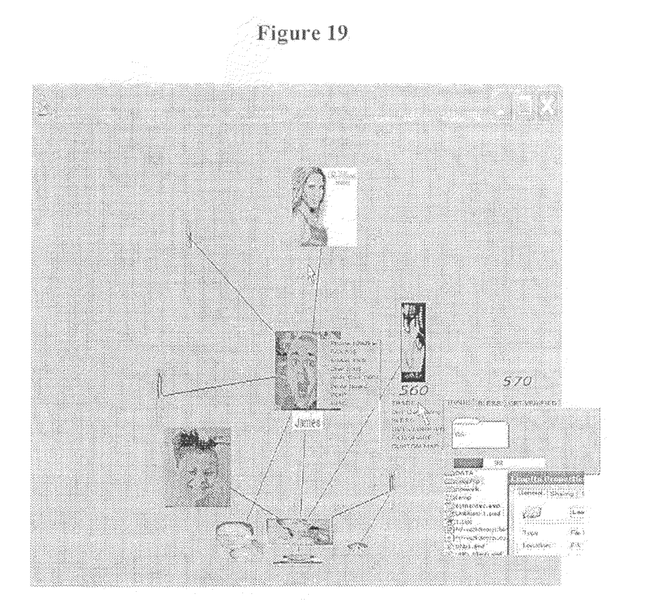

Referring to FIG. 19, is based on FIG. 18's method of trading where files can be traded from the local hard drive.

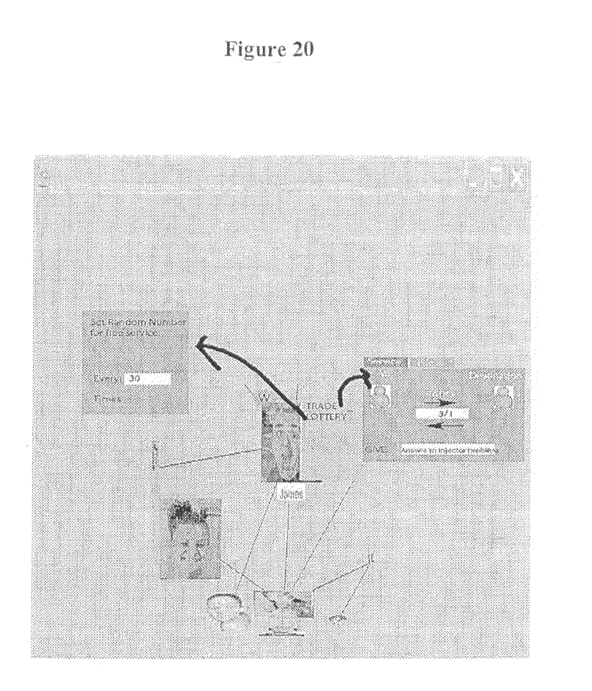

Referring to FIG. 20, is base on FIG. 18's method of trading based on ratio for physical files (I upload 1—you give me 3=Ratio 3 to 1) or virtual services (In this case some one was looking for an answer for a cars injector problem).

Another feature in FIG. 20 is the lottery option that lets users get a free service or file (In this case every 30 services or can be configured for a random number) which might increase business traffic.

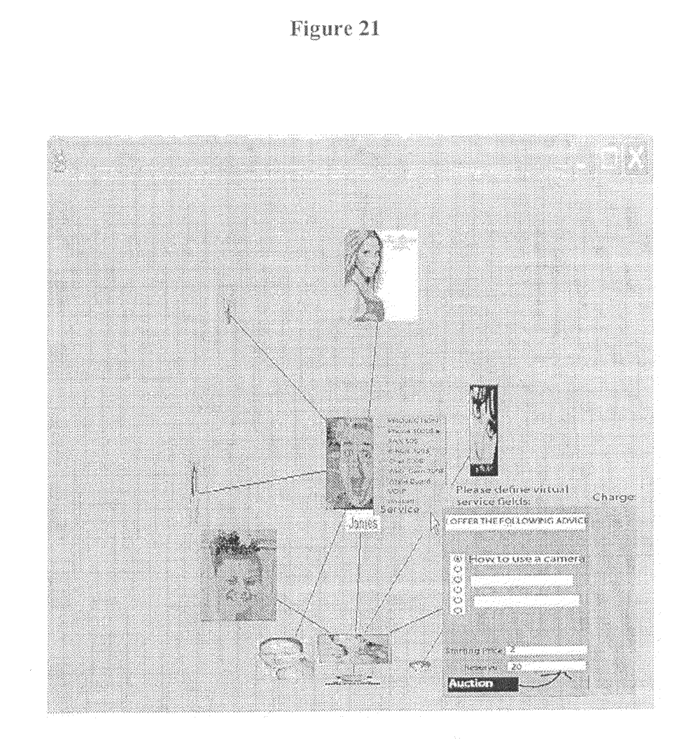

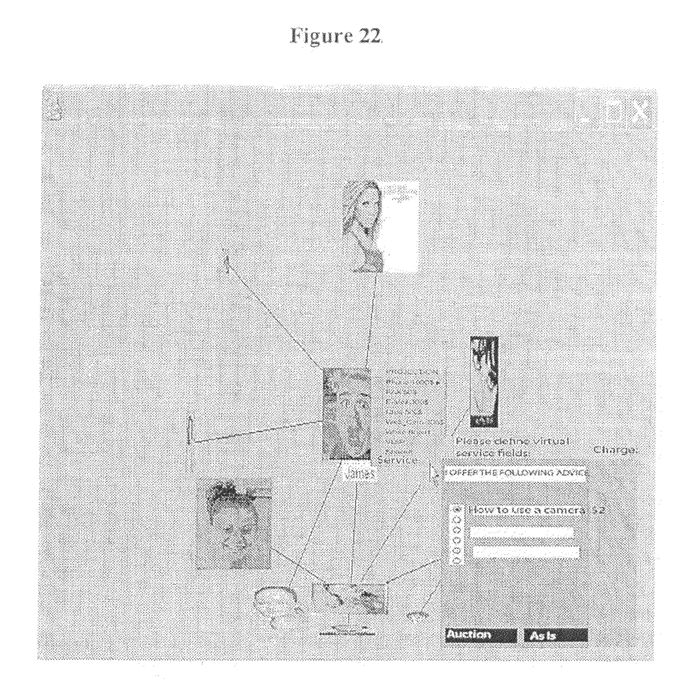

Referring to FIG. 21, is a method of auctioning services or files to the highest bidder (might increase business traffic and provide bargain deals). Features include but not limited to: Starting price and reserve.

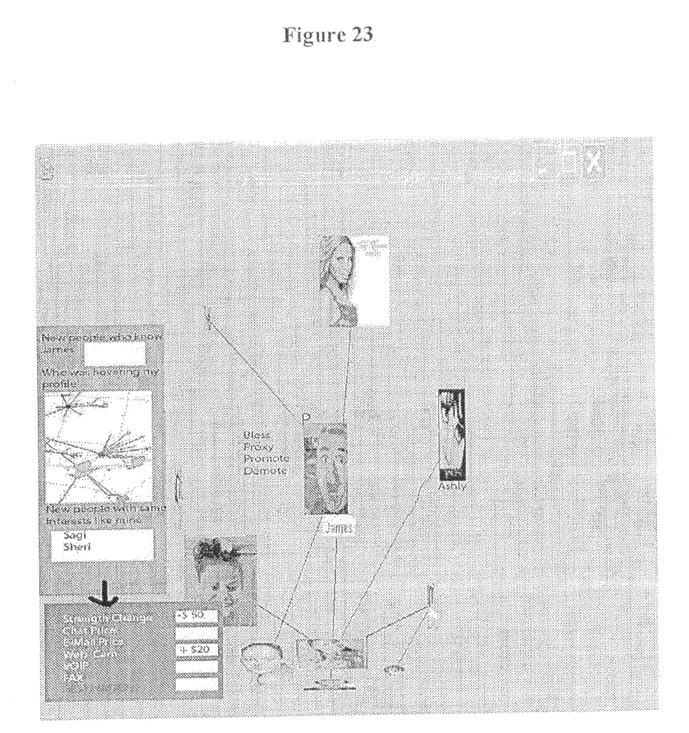

Referring to FIG. 23, is a method of defining a “Proxy” user in the database which delegates some or all the service offerings and their benefits from one user to another (Represented by the “P” letter and an orange circle behind it).

This feature is used in order to free up users who might have their queues full with requests but would still like to cater to new and additional users seeking service.

Another reason a user might choose to proxy is because he is away and trusts someone else to provide the “Goods”.

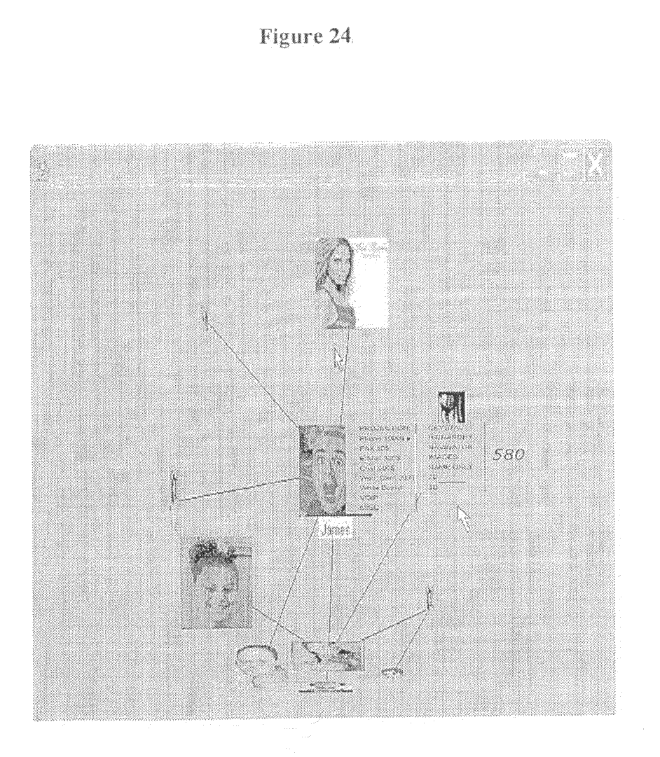

Referring to FIG. 24, a sub menu (580) lets a user choose a variety of GUI's (Graphic user interfaces) such as: Birdseye view (Crystal), Hierarchical (If corporate, company), Name Only (For users with slow computers or low bandwidth), 2D or 3D.

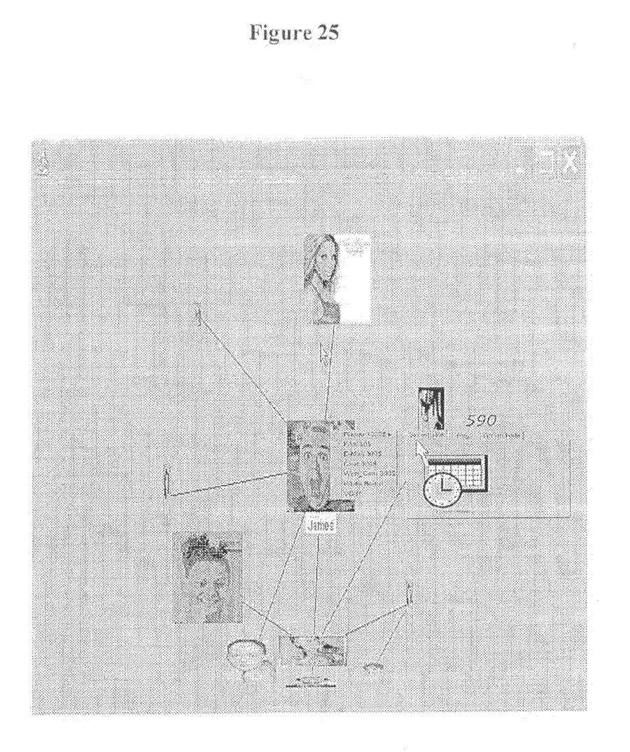

Referring to FIG. 25, is a method of looking at a destination or relay's users scheduling (590) on a per service basis.

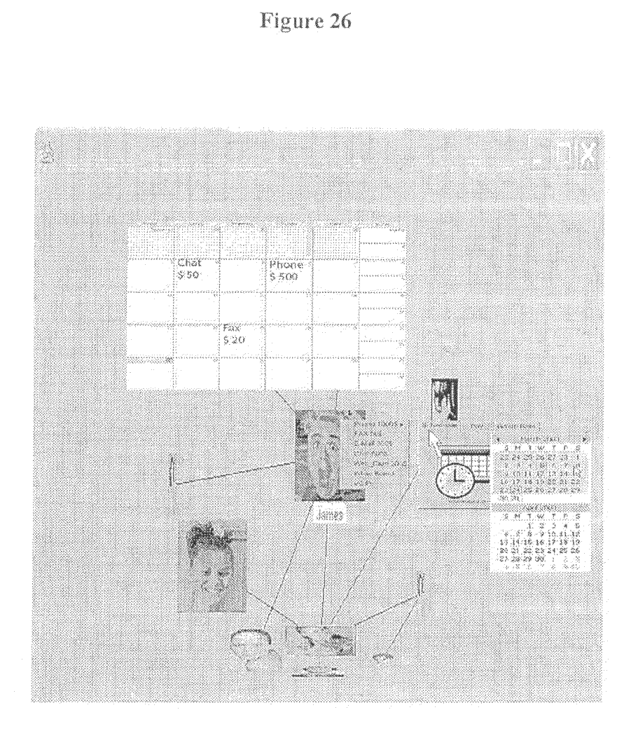

Referring to FIG. 26, is a presentation of a method of scheduling a service for potential users to buy based on varying dates/times and prices. (This is a good solution for people to make more money on weekends or less money at 1:00 AM)

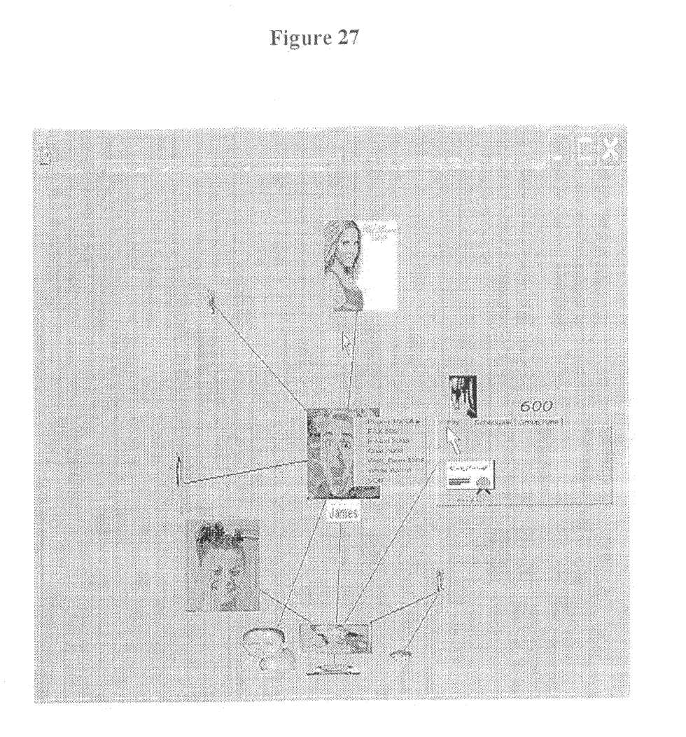

Referring to FIG. 27, illustrates a menu with a payment option which directs the user to a 3^{rd} party billing mechanism: PayPal, Credit Card companies etc.

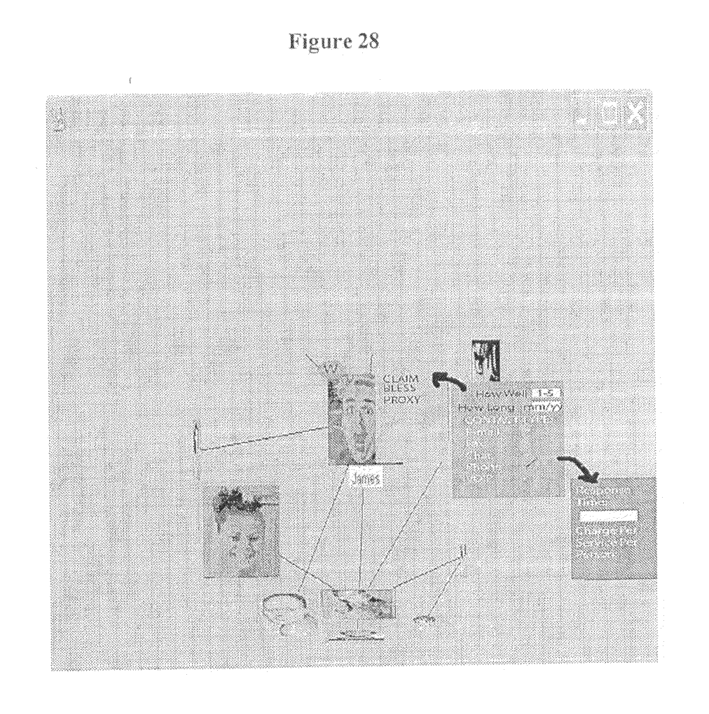

Referring to FIG. 28, is a process of a user claiming to know another user (Relay or destination) which in turn builds the complex network based on parameters that are used for statistics gathering and as metrics such as: Relationship Strength (1-5), Relationship, Methods of contact, Response time etc.

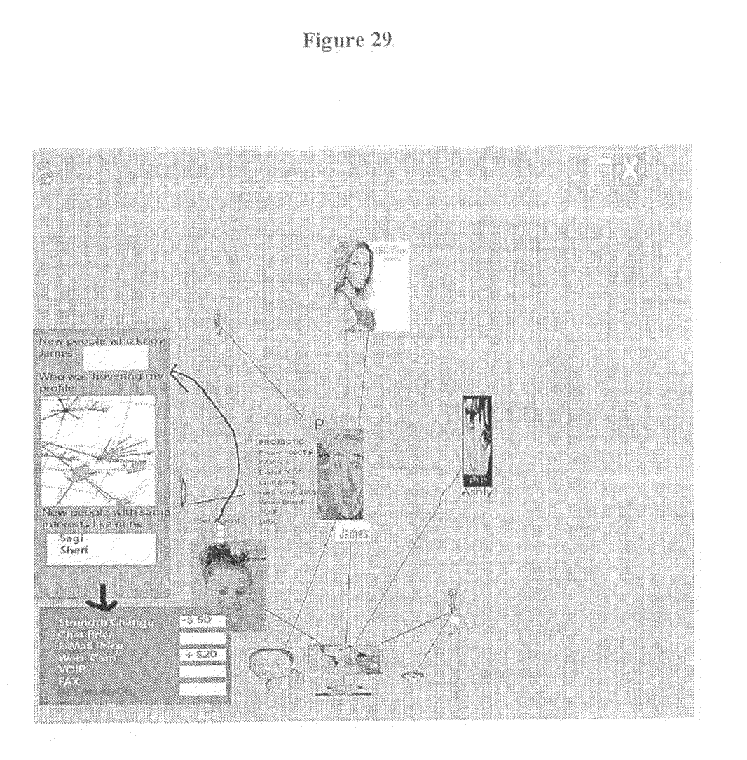

Referring to FIG. 29, is a method of setting an agent and a monitor (Upper Left Figure) that populate in real time based on parameters and metrics defined such as: New people who claim to know “Me,” Users who have been hovering (Searching for a destination and “I” was on the path as a relay), New users with interests like “Mine”.

One can also set an agent (Bottom left figure) to poll information about a link/spline strength change, Price change per service per person etc.

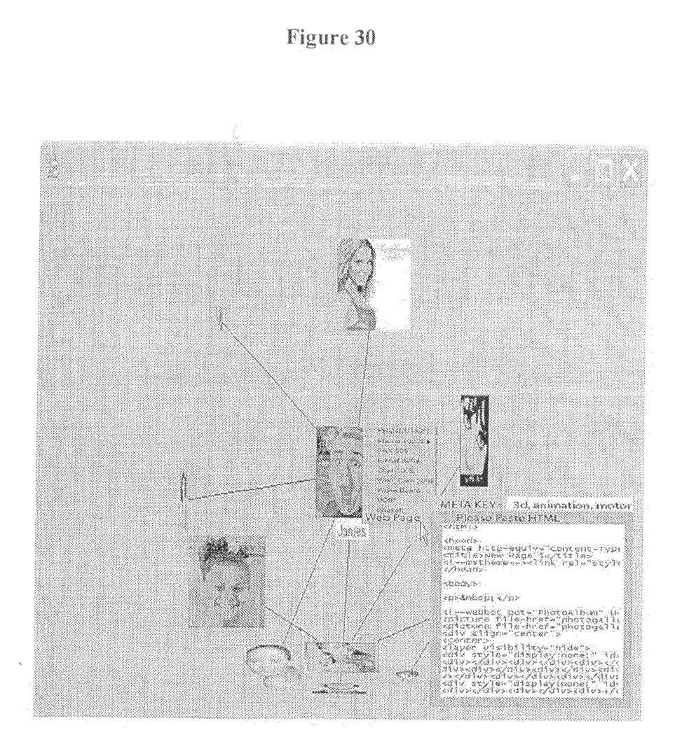

Referring to FIG. 30, is a method creating a web site on the fly in real time by a user by just cutting and pasting HTML code into a windows which in turn is saved on the system's server and indexed based on the META data.

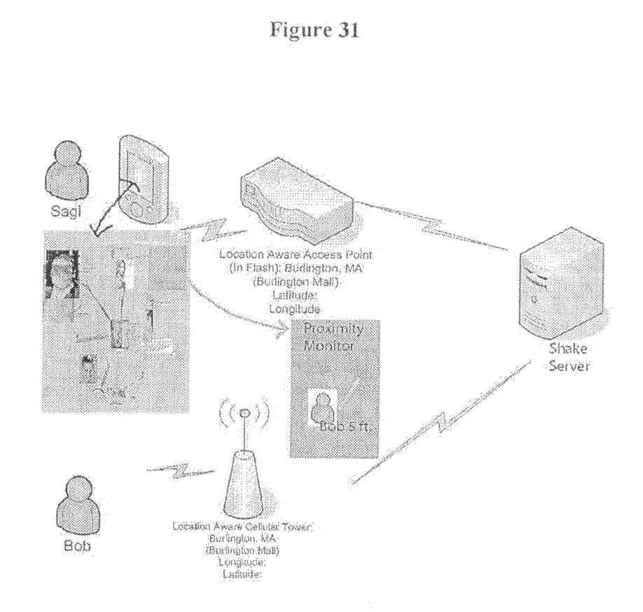

Referring to FIG. 31, is a method where a “Proximity” monitor is used. User Bob and User Sagi are walking in the same Mall in the same city a distance of 5 ft from one another. A geographically self aware device such as a wireless hotspot (802.11x), GPS or a cellular tower (GSM, CDMA) are notifying the clients (PDA and Smart Phone) of their proximity (5 ft) and then the system application is checking in the database for a match of interests and other info that the 2 users share in common while notifying them of their physical proximity and need/offers.

A sonar like GUI is used to show proximity and a 2D or 3D system map notifying users about the common interests.

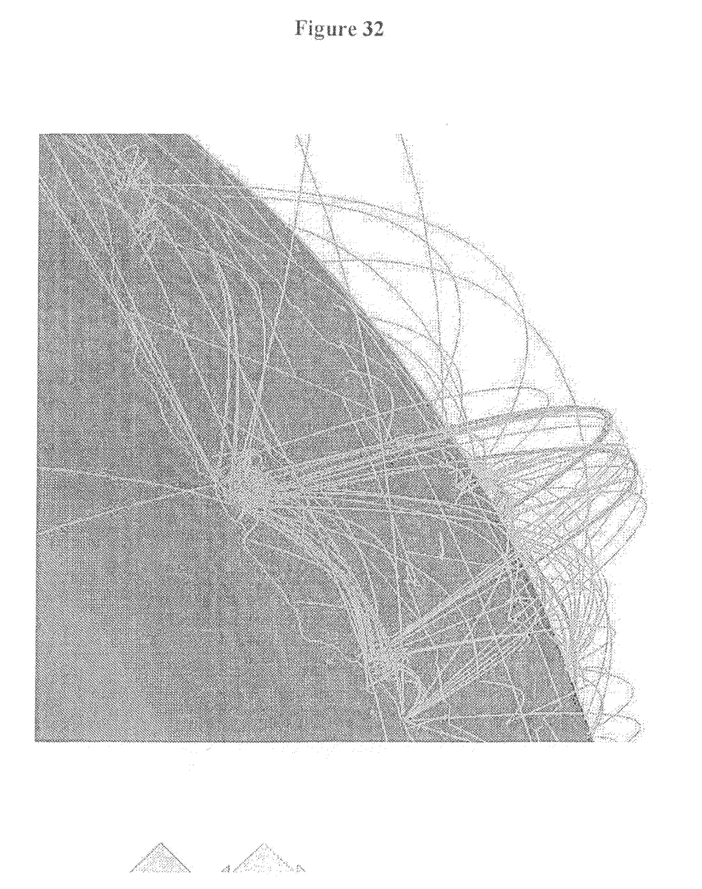

Referring to FIG. 32, Is another 3D representation of users and their respected links based on geographical location on earth.

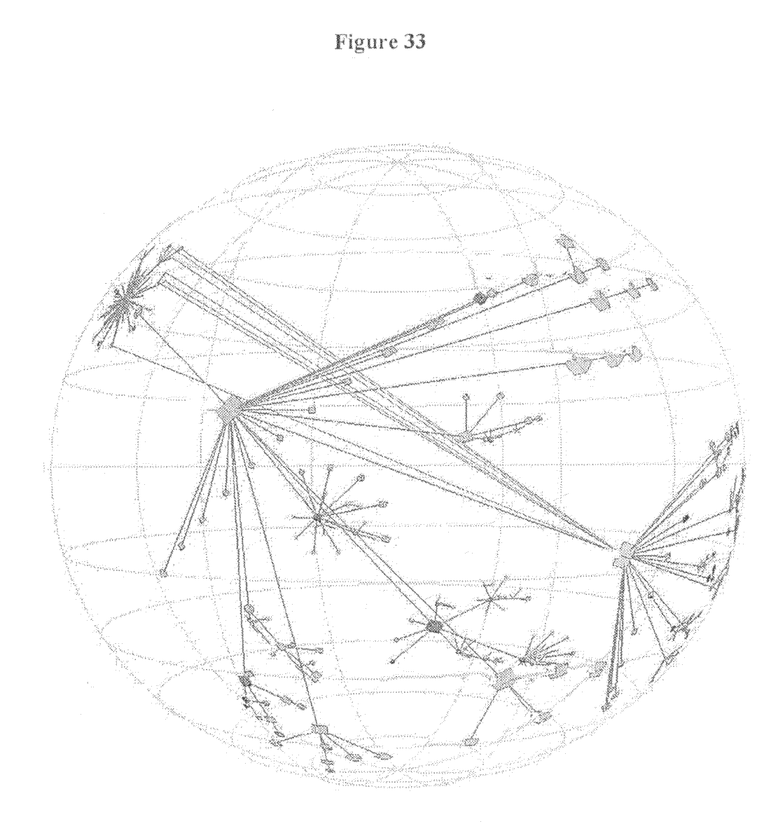

Referring to FIG. 33, is a method of visualizing the “Universe/World” in 3D with the ability to manipulate the universe in all 6 directions (Left, Right, Up, Down, In, Out) and it's content (Links, User (Photos), Icons etc).

Noticeable are also the links with are 2 layered: a. abstract
b. Hierarchical (Representing a company)

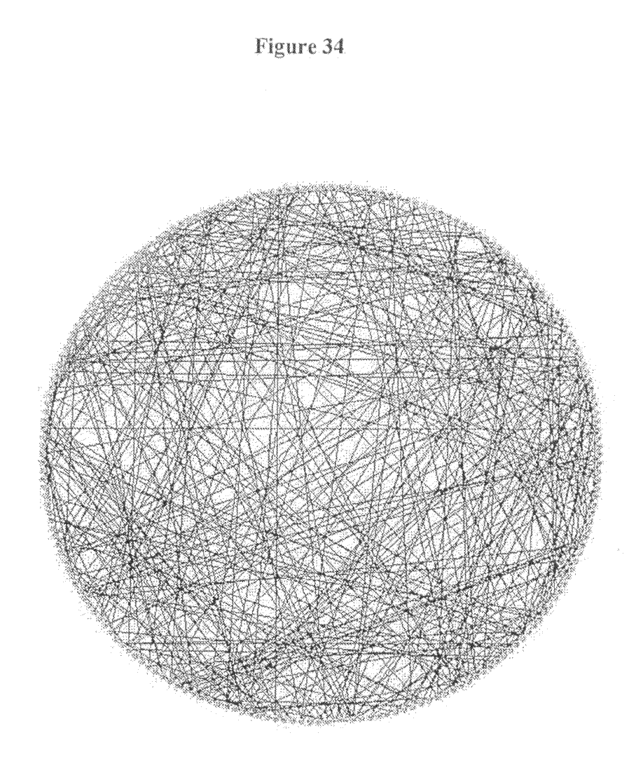

Referring to FIG. 34, Is a representation and GUI of the 3D world in Full zoom and nodes on the edges in order to see the complexity of links in one area and the users on the edge of the sphere.

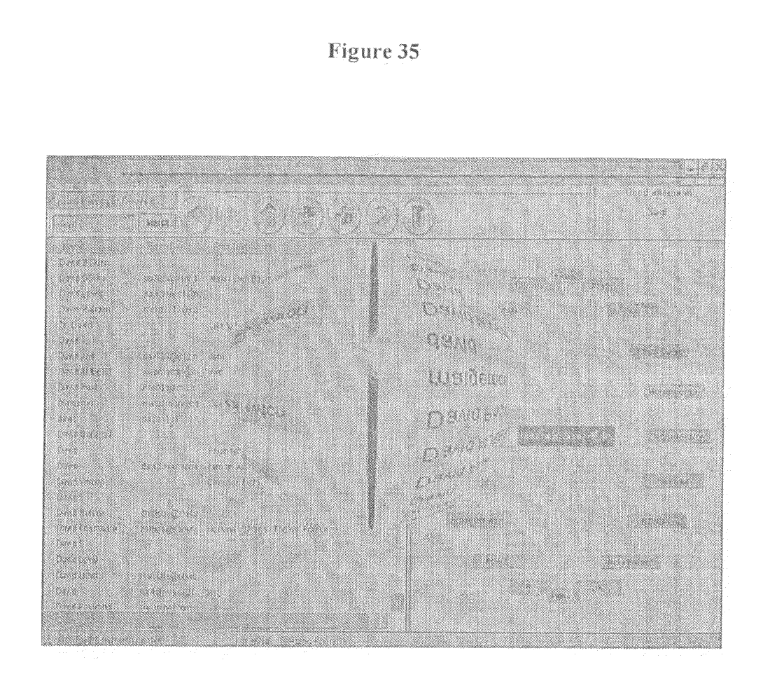

Referring to FIG. 35, Is a GUI representation of the 2d map with parabolic projection (Crystal Ball) where there is a need to converge links due to information visualization overload.

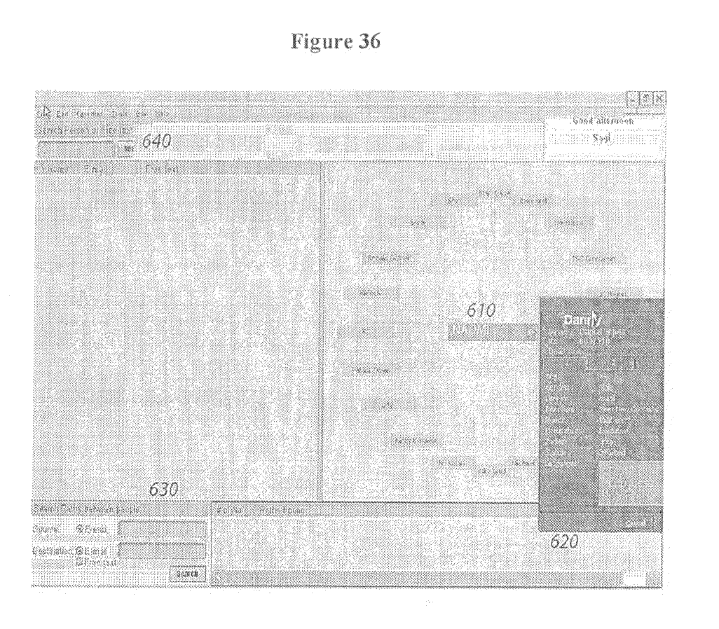

Referring to FIG. 36, is a TAG that pops up once the cursor hovers over the users name and presents personal info about the user such as: Gender, Age, occupation and so forth

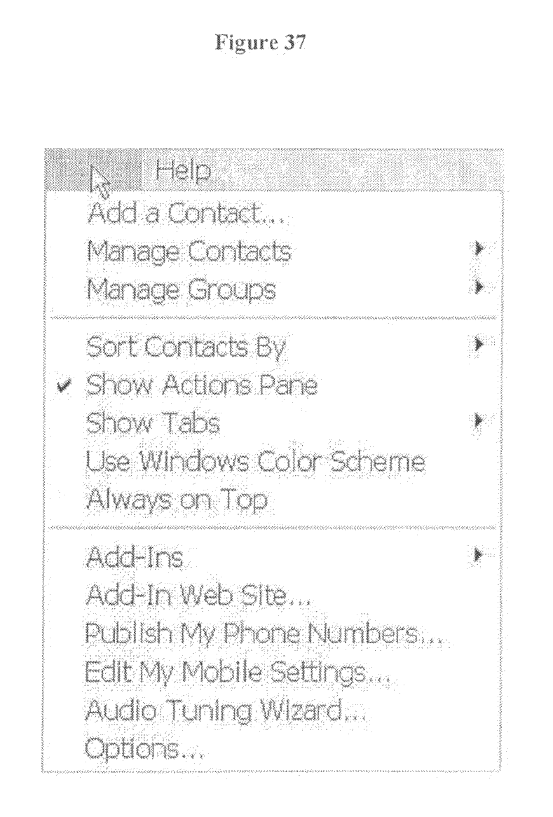

Referring to FIG. 37, is a calendar synchronization mechanism where a user can pull the database from other users about their links from know applications such as Microsoft outlook or links accumulated by the user's activity. This approach is suitable for users who do not care about security or being verified.

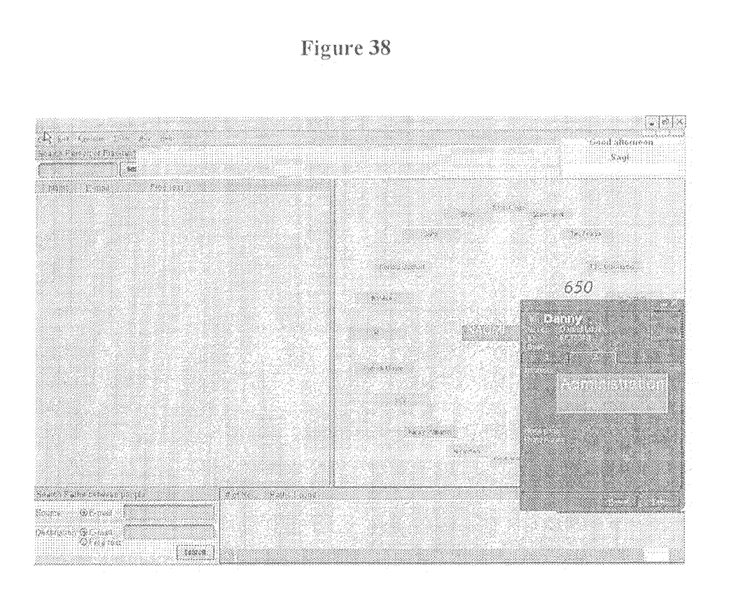

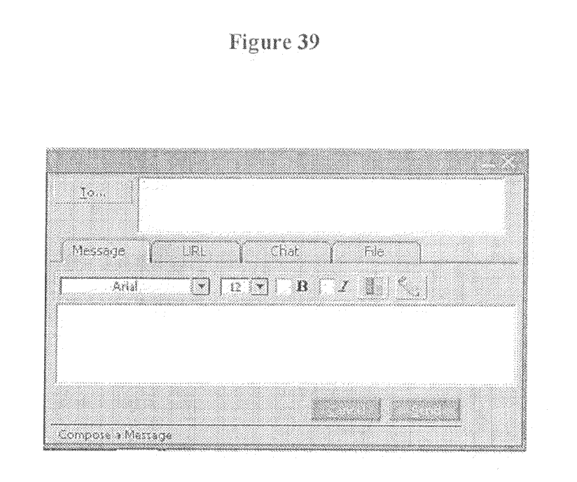

Referring to FIG. 38, Is a menu created by hovering on a user that had published a website.

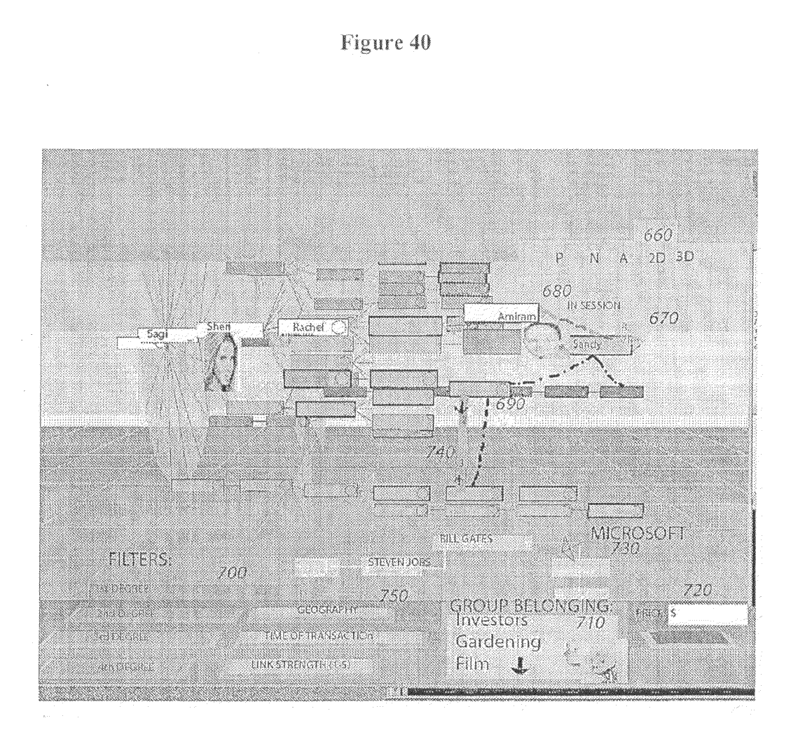

Referring to FIG. 40, is a 3D and 2D GUI enabling both hierarchical view (730) and abstract. The user Amiram(680) is in an active session with Sandy which is represented by an animated dotted line of multiple colors and means that they are busy.

Above user sandy (670) is an Icon (R 78%) with a blue circle behind it which represents ratings fort his user (78% pro) that way a user does not need to go to a different HTML screen to see basic details.

Icons at the top right (660) represent different world views.

Filters are implemented as graphic icons (700) that can reduce information by degrees of separation.

Interest Group associations are presented as a legend (710) and a search by price range (720) is an option.

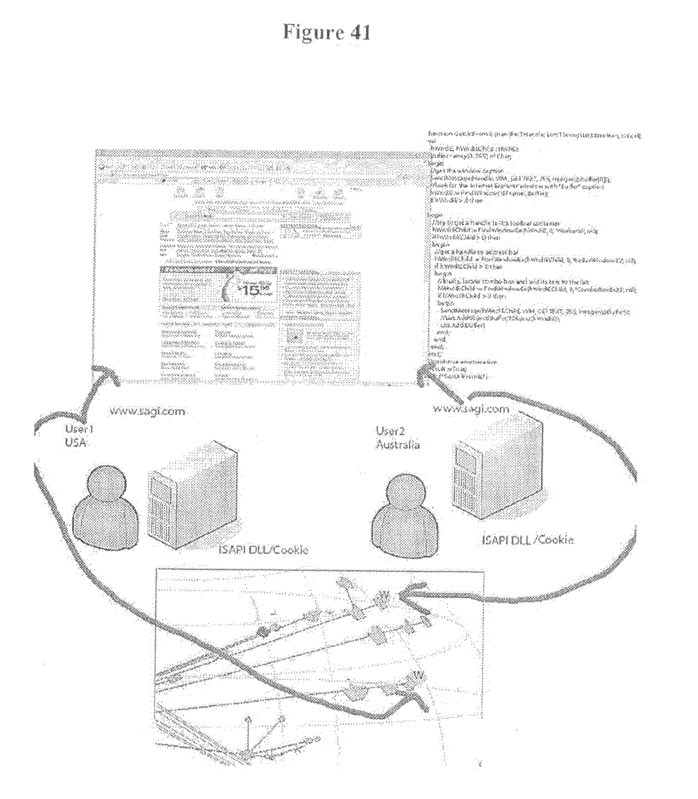

Referring to FIG. 41, is a method of alerting users that are surfing the same website concurrently. The top left figure is the website, On the right is source code in the Delphi language used to extract the URL from the internet browser.

Presented are 2 users from different geographical locations surfing the website: www.sagi.com, The information from the URL or cookies is extracted, transferred to system's database server that in turn represents their activity on the 2D and 3D maps by a “W” letter and a red circle behind it.

This method brings people who are at the same website closer under the philosophy that they might have something in common.

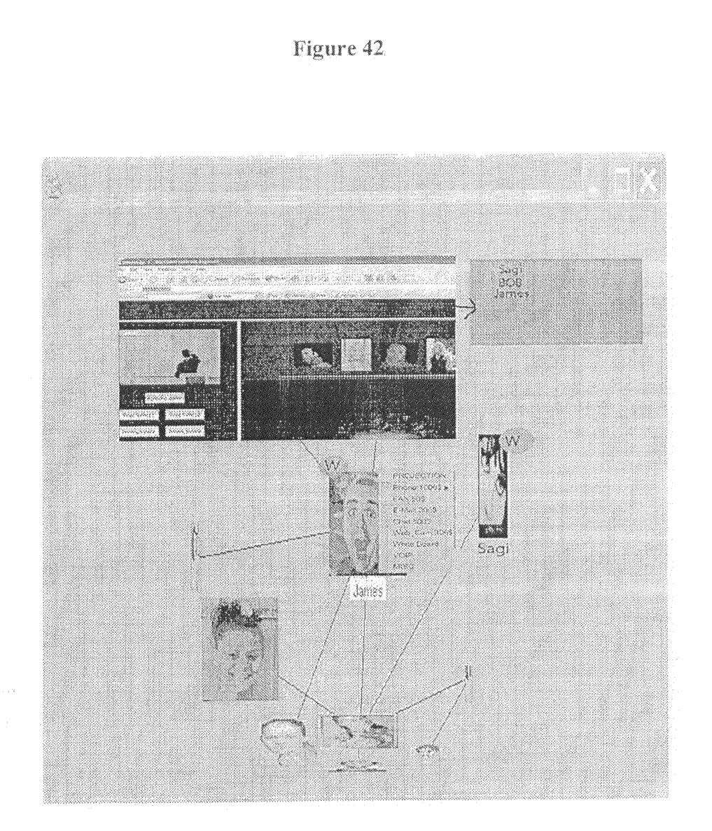

Referring to FIG. 42, Is an extension of FIG. 41. and represents 2 users with the same “'W” Icon indicating to them that they are surfing the same website.

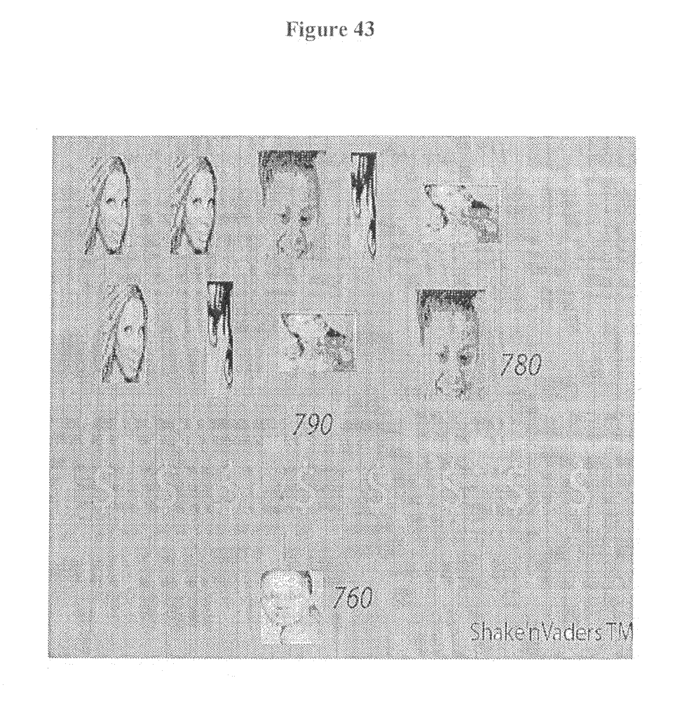

Referring to FIG. 43, Is a method of utilizing the database module for entertainment and games creation. Games engines can utilize Pictures, Sounds and even metrics provided by the system to create fun and engaging games. Illustrated here is a “Space Invaders” game based on peoples pictures.

Games can be 2D or 3D and the system provides a platform for development.

In this example a spaceship(760) in the game “Invaders” is shooting “Links” (790) and hiding behind protectors (Dollar signs) shooting spaceships (Other people's pictures—780)

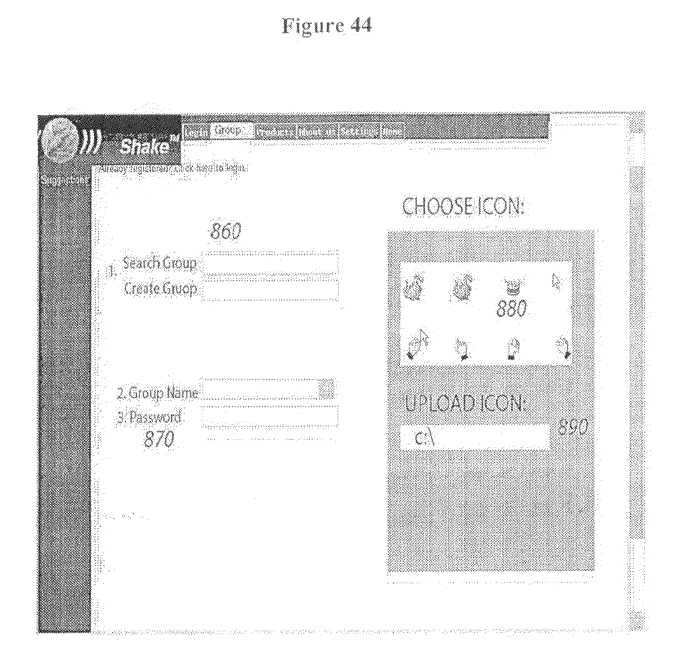

Referring to FIG. 44, Is a method of creating a group for collaboration and mutual benefit and enabling that group only to its members. The group chooses an ICON (880) that in turn is represented on the interactive map GUI's. The group is created (The first person who creates it by default becomes its moderator. A password (870) can be assigned to a group and a requirement to pay in order to join via a 3^{rd} party (PayPal) is a possibility.

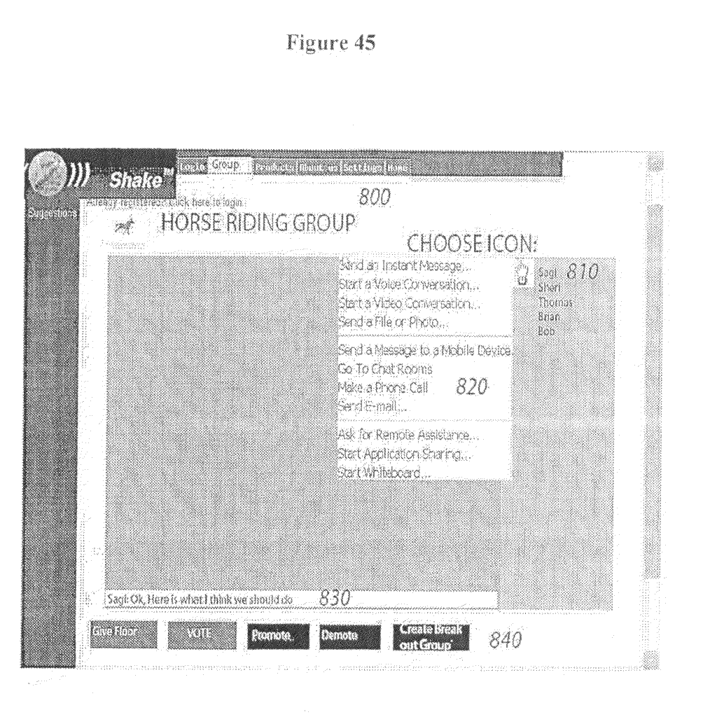

Referring to FIG. 45, Is a method where the group is a “Democratic” group that has a leader which is considered to be the “Power User” and the Floor Holder. No person can communicate with one another unless permitted by the group leader. There is also a breakout group where users can create their own “Sub” groups.

The “Hand” Icon next to the user Sagi represents the Floor Holder who is the super user that is able to ban people from the group, Promote and demote.

Different collaboration tools are enabled (820) such as: Video, VOIP, Whiteboard, E-mail and so forth.

Is this case the user Sagi is saying (830) “Here is what I think we should do”

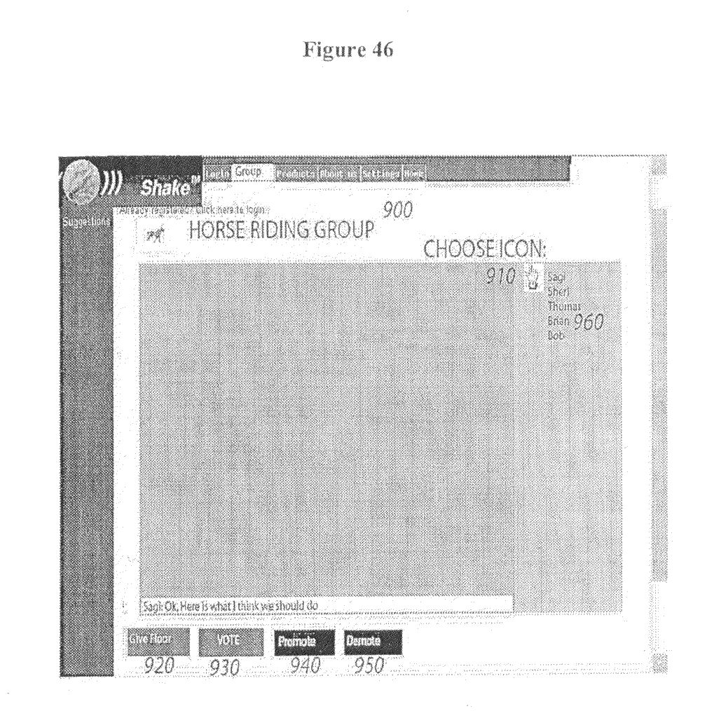

Referring to FIG. 46, Here is a representation of the groups name and Icon (900), the floor holder (910) and several users (960), When the super user (Sagi) gives the floor (920) some one else becomes the power user and everyl else can communicate only with him.

A user can Promote or Demote another user and create an voting system in place,

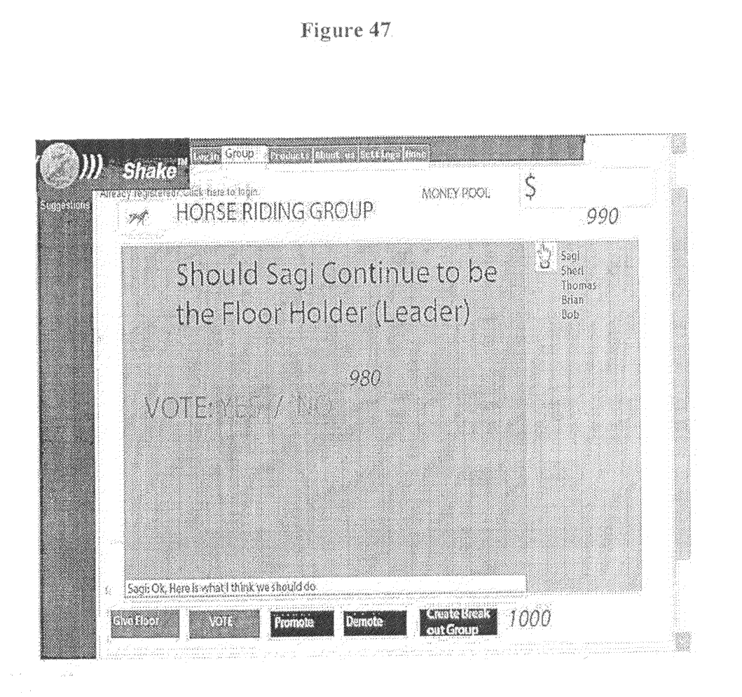

Referring to FIG. 47, Is a method where voting on a virtual subject (“Should Sagi continue to be a floor holder”) is combined with a money pool(990) being created temporarily by the members of the group which in turn is used to support an activity agreed upon all members from investing in stocks to buying wholesale merchandise.

Users have to choose Yes or NO(980) in the voting which could relate to who to promote to being the leader of the group to where to wire the money accumulated in the pool for a purchase of some goods agreed upon the majority of the members.

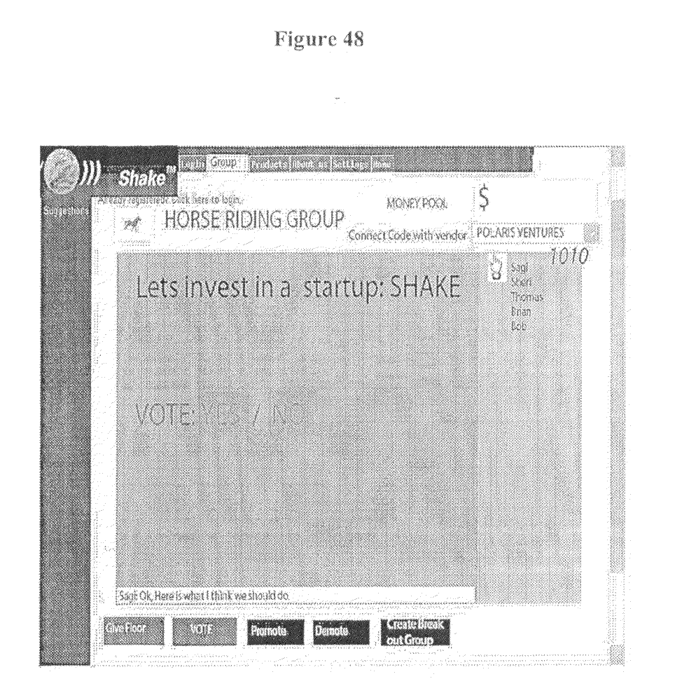

Referring to FIG. 48, Is where a piece of system-generated programming code is able to interact with various service providers (Financial services, Wholesalers etc.) and the money pool is routed to those sources in order to receive benefits such as discounted prices for he group members(1010). This is a similar concept as the code a webmaster has to paste into his website in order to provide secure connections with 3^{rd} party companies such as GTE, Verisign etc.

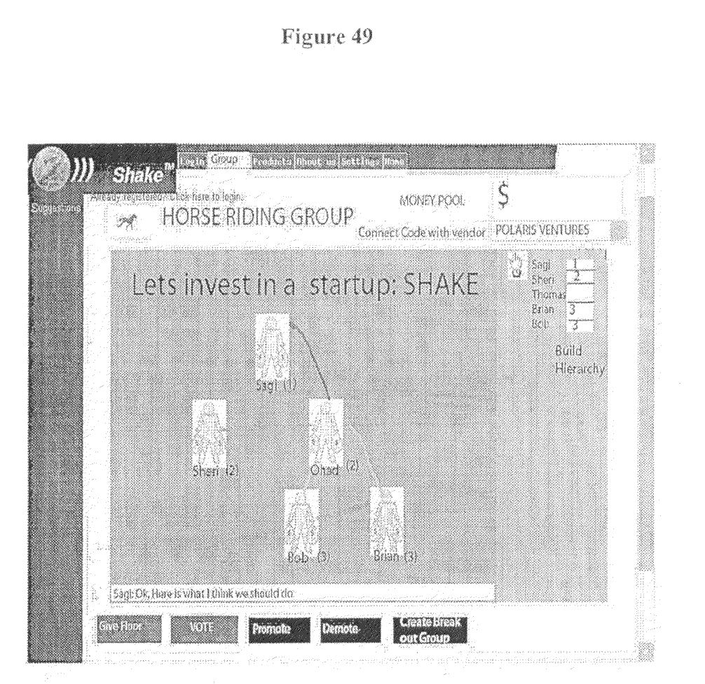

Referring to FIG. 49, Is a method of building a hierarchy from the group members with deferent sets of powers represented by numbers. This emulates a real political setting.

In this case user Sagi has build a hierarchy where User Bob and Brian are on the same level. (Numbers typed next to the names). Promotion and demotion can occur in this type of setting.

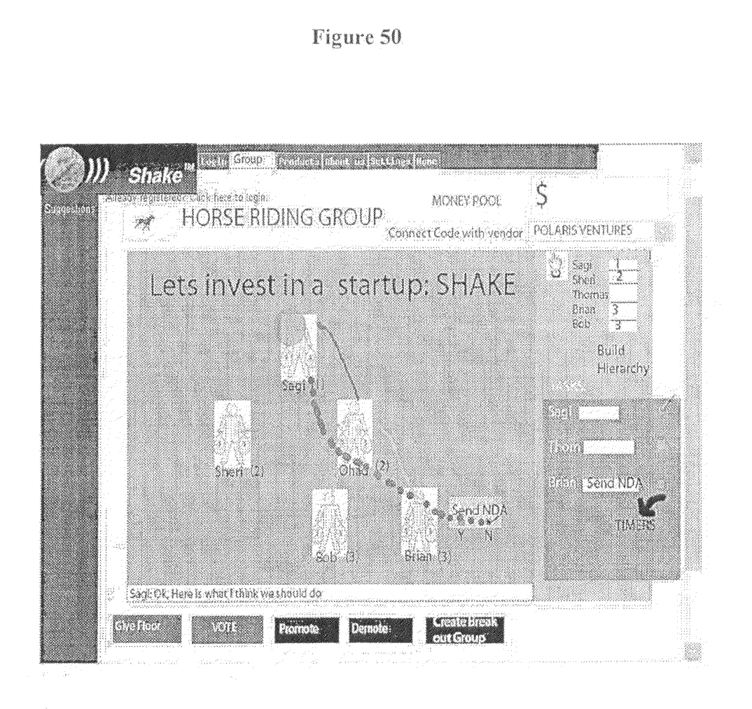

Referring to FIG. 50, Is a method of assigning virtual tasks to the members possessing different importance levels and the ability to create an agent to monitor these tasks and report up the groups hierarchy or even the system's world hierarchy if a certain threshold was reached and represent it utilizing a color scheme. In this scenario Brian was suppose to send an NDA based on a timed event which wasn't successful and the problem escalated and propagated up the hierarchy to the User Sagi with a flashing red light or other form of annunciation.

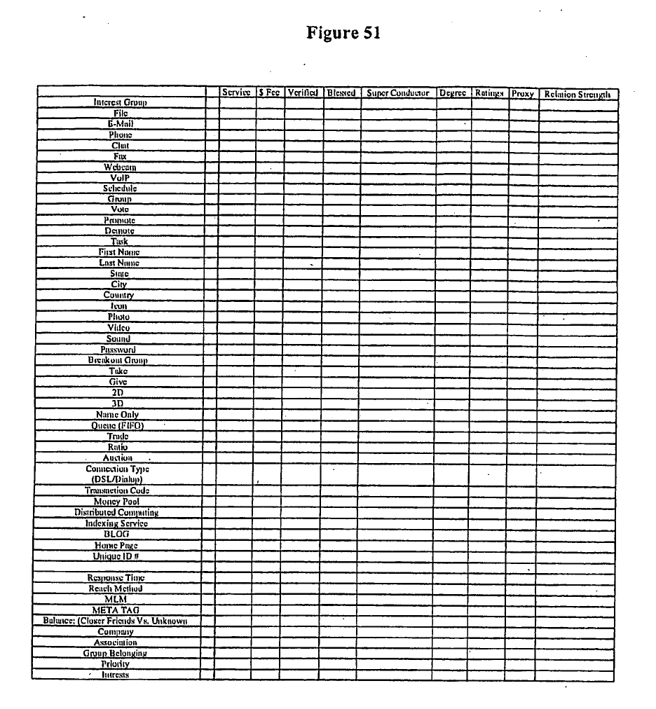

Referring to FIG. 51, represents but is not limited to the different variables in the database module that enable the complex computations in order to reduce the path's cost and advanced search abilities.

Referring back to FIG. 3, a general overview of a first server 20 and database module 10 are connected to a plurality of client computers (80,110) and users over an internet connection (WAN) 9. It should be understood, however, that other networks can be used instead of the Internet, such as an intranet, an extranet, a virtual private network (VPN), Wireless, a non-TCP/IP based network, or the like. More than one server 20 may be provided wherein all servers are preferably continually synchronized to maintain and supply the same information for load balancing, high availability and fault tolerance reasons.

The clients (80,100) typically run a browsing program, such as Microsoft's Internet Explorer, Netscape or Opera. Each client also typically includes one or more user interface devices 32, such as a keyboard, a mouse, touch screen, pen or the like.

If both the first server 20 and the recipient clients (80,100) are protected by firewalls, a proxy server is used to facilitate the transfer. The client and the first server both connect to the proxy server, which then allows data to flow and hence the communication and address translation to occur between the recipient client and the first server through the proxy server. The interface between server 20 and the database 10 is enabled by using the Open Database Connectivity (ODBC) protocol. ODBC, JDBC. The database is an RDBMS or an Object oriented DB and is well-known in the art and therefore will not be further discussed. Connected to the first server 20 are multiple service servers 40 running web servers (IIS-HTTP), Mail servers (SMTP), indexing and search engines/servers and server side scripts residing on the servers. Web server 40 is typically a programmed computer, more specifically one which supports a Hypertext Transfer Protocol (http), that handles requests for records, documents and other services, and transmits such information over network 90. Network 90 is, for example, the Internet. Many suitable software programs for Web server 40 exist, including Netscape, Apache and Microsoft IIS.

In one embodiment, the search engine, indexing engine and database module exist in the same process. In another embodiment, search engine, indexing engine and database module exist on different processes, but run on the same machine. Many configurations of machines, search engine, indexing engines and database modules are possible.

The database is used to store user subscription and account information in tables, records and fields including but not limited to: profiles, billing, relationships, hops (degrees of separation), websites, blogs, metadata (preferences etc) and will be discussed in further detail later.

Search engines, indexing engines and the SQL query language as known in the art can also be employed in the system.

Communicating with first server is an IVR 30 server (Interactive Voice Response) which is comprised of telephony equipment (Modems, ports etc) that mask (encapsulates) real physical telephone numbers of users using the system. The system pushes/pulls telephone number info from user record's telephone fields and provides a password based system for users seeking telephone communication with other users utilizing a 1-800_XXX-XXXX number or any other static paying telephone number. The password provided by the IVR machine is a per session password and is terminated once session is closed. IVR 30 uses ports connected to modems that receive calls from users around the world via the PSTN (POTS) network or cellular networks connected to a PBX and provides an interface and controller software to connect to database module 10 utilizing VoiceXML protocol language or any other non-proprietary protocols. IVR machines are known in the art and will be discussed in further detail later on.

Illustrated are also multiple layered services/contact methods (VoIP, Webcam—H323/CIF, E-Mail—POP, Online Presence—Chat/IM, White board etc) that are offered by the system to users and clients powered with the option of charging per service while maintaining security, anonymity and profiting/gaining from such activity.

The following are detailed step by step procedures explaining the system and its operation which are comprised of illustrations, flow charts and scenarios (simulations/study cases):

The first step for a new user to use the system is to create an account and register into the database:

### Account Creation

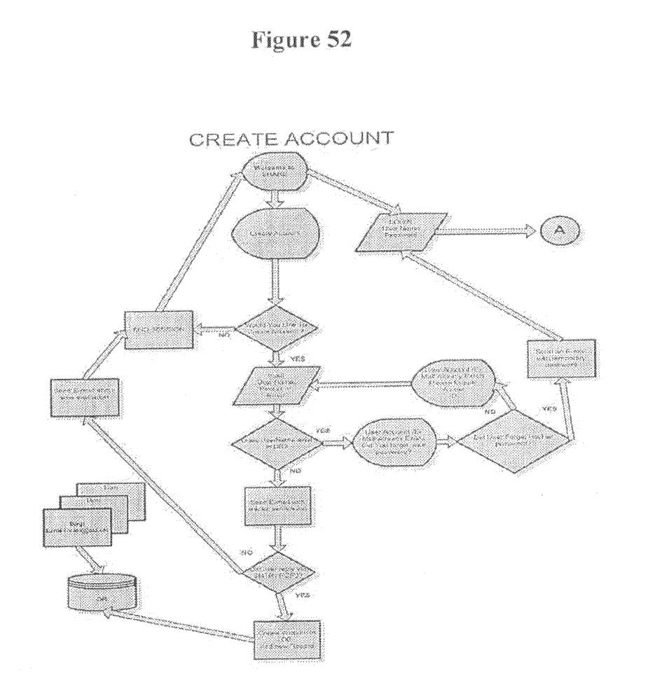

FIG. 52, Is a flow chart demonstrating the steps needed to become a member.

A user employs a client computer via a web browser (Internet Explorer etc) and a network connection (WAN, LAN, WIRELESS) to communicate with the system server and data base module. The user inputs the system's website address (e.g., Shake.com or an IP address) into the URL (Universal Resource Locator) utilizing a keyboard and connects to the HTTP web server (IIS, Apache etc). Once establishing a connection via the TCP/IP protocol with the server, the system's default website's HTML page is presented to the client welcoming him to the site and service.

The new user can be presented with 2 options:
1. Create a new account (New User—User does not exist in database record)
2. Login (User record exists in database)

When the user chooses the first option (Clicks on an ICON) a routine is executed asking the user to provide a User Name, E-mail address and Password, in the next step the systems queries (SQL Query) the database to look for a similar user in its records. If the User name or E-mail address does not exist the routine proceeds to the next step where a user is sent a notification e-mail in order to validate and authenticate that the e-mail address is a true and operational one, one method employed and known in the art is to use a distorted graphic text that the user has to repeat as an input in the e-mail in order to be verified (Prevents BOTS—automatic spam generators from taking advantage of the system and creating multiple accounts and saturating the database with user records).

The user finds a link to the system website in his/her e-mail to complete registration. If the user did not respond in a predefined times slot the database purges the request and any record associated with that user.

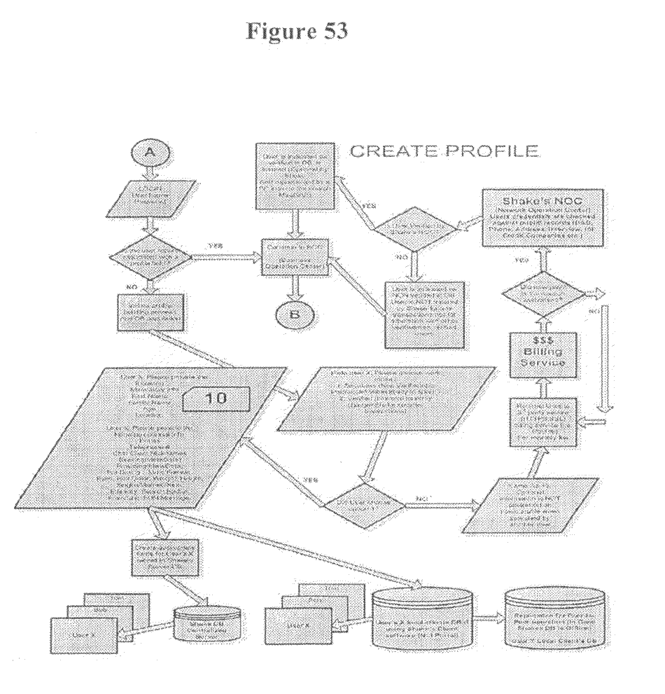

After the user has replied to the e-mail, the server processes the e-mail and creates a new record in the database for that user and proceeds to profile creation FIG. 53 which adds many parameters to the user records fields later used for metrics and relationships.

If a users account already exists and a new user is trying to create an account using that name or E-mail address a routine is executed asking the user whether he forgot his/her password. If the user did forget his/her password, they are presented with a field where they type their e-mail address and the password will be sent to them, if the user does not choose to send password to e-mail the routine assumes that he does not exist in the database and loops back to the account creation and input screen where the user can choose a non-existing name/e-mail address.

### Logging In

When a user record exists in the database, a user clicks the “Login” icon on the system website and his/her credentials are checked against the database FIG. 53(A). Once the Login process is successful and authenticated a routine is executed to check whether a user has an existing profile in the system.

### Profile Creation

If the user does not have a profile a routine is executed which options the user for two choices: secureless Vs. Verified. If the user chooses option 1 (Secureless) an input screen (10) is invoked where the user provides personal information later used to create relationships and metrics for various search algorithms and mechanisms. Information such as: Age, Geographical Location, E-mail address, Telephone and dating information: Height, Weight, Eye/Hair color are utilized and pushed into the appropriate fields of the user record in the database. All data will be available for other users to watch and use. The users transactions will not be insured by a system administrator. Option 1 also utilizes a distributed Peer-to-Peer system. A Peer-to-Peer approach enables parts of the database to be implemented locally on client computers and encrypted, this helps to reduce the overhead on the central database module for users who do not care to use the secure environment.

If the user opts for option 2 (Verified) his personal information is not presented to other users in the search process.

Option 2 calls a routine that redirects the user to a 3^{rd} party secure (HTTPS/SSL etc) billing service (PayPaL, Credit Card Company) in order to subscribe to a monthly fee paid to the order of the system administrator that insures transactions gone bad between users and also marks the user as a genuine one after the NOC (Network Operation Center) has done extensive due diligence to verify this individual, procedures such as D&B/Credit records, telephone/address and ISP (Internet Service Provider) verification are employed.

If the user is verified, he or she is presented on the map with a “V” icon, also a corresponding field in the users record in the database is populated indicating they are known to the system as verified users.

Option 2 a secure server to protect and secure users from imposters and at the same time provides additional services.

If a user is not verified for some reason, the user is notified and the routine proceeds to the BOC (Business Operation Center) where the users define services and individual charges (B).

### Business Operation Center (BOC) (Multilevel Charging System)

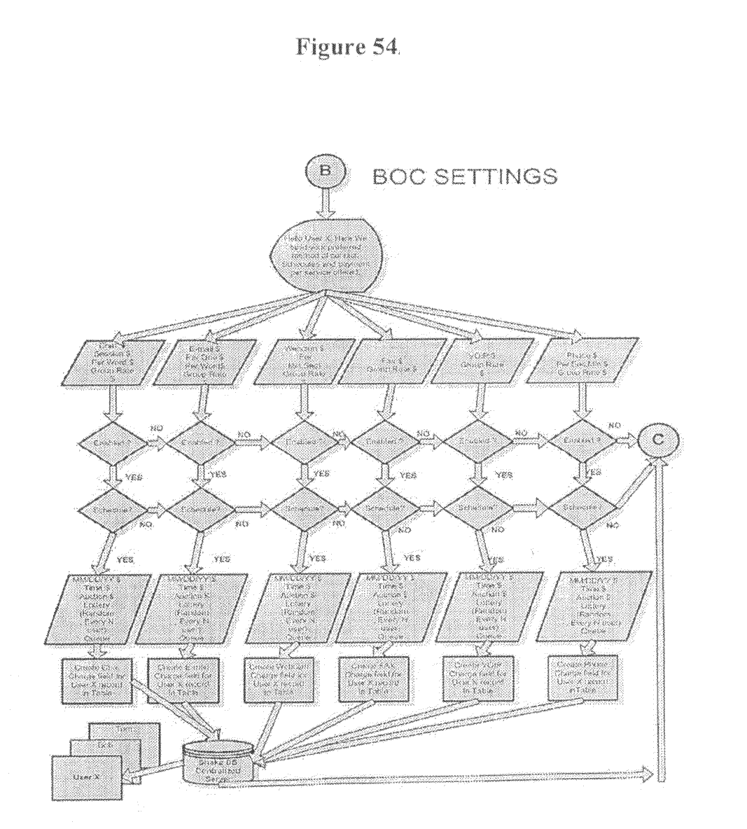

Business operation center FIG. 54, is a flow chart representing an embodiment of the system. A user receives a prompt request that he enter and define different methods of contact and the fee associated with each one.

Presented are distinct 6 (Not limited to) methods of contact: Chat, E-Mail, Webcam, Fax, VoIP and phone.

Chat: The user can set a fee associated with a chat client (Instant messaging, Online presence). The chat client can be the default system proprietary chat client or known solutions such as: AOL's Instant message or Microsoft's MSN messenger.

The user can set up a charge based on a sessions duration (Time-Per Second, Minute or Hour), Per word. The user may also define a group rate that enables several users to converse at the same time for a discounted rate. Once the user defines these variables they populate the database in its respective fields of the users record.

The routine provides for enabling or disabling a specific method of communication/contact. Once the user chooses to enable a service and assign a fee he is transferred to the scheduling routine, if he chooses not to schedule or enable a service he is transferred to the next step (C) which is GROUP, HOMEPAGE and BLOG settings.

If the scheduling is enabled the user is prompt to provide the following: Year, Month, Day, Time and queue length for people waiting in line for service. The scheduler is proprietary system solution or an integration with known schedulers such as Microsoft's Outlook from the Microsoft Office suit.

Two more options are available for the user to choose from:

Auction—A method in which a user can set a service for the highest bidder, a concept well known in the art i.e.—Ebay, Only that is this case the auction is provided on a service level and not a physical product. Parameters such as minimum bid and reserved price may be employed.
Lottery—A method where a user can define a random or a cyclic event in which a user seeking service can win a free service session.

Both Auction and lottery settings are represented in the database fields corresponding to the user's record.

Steps needed for the rest of the services (E-mail, Phone etc) as described above will not be further discussed here since they employ the same procedure and will be repetitious.

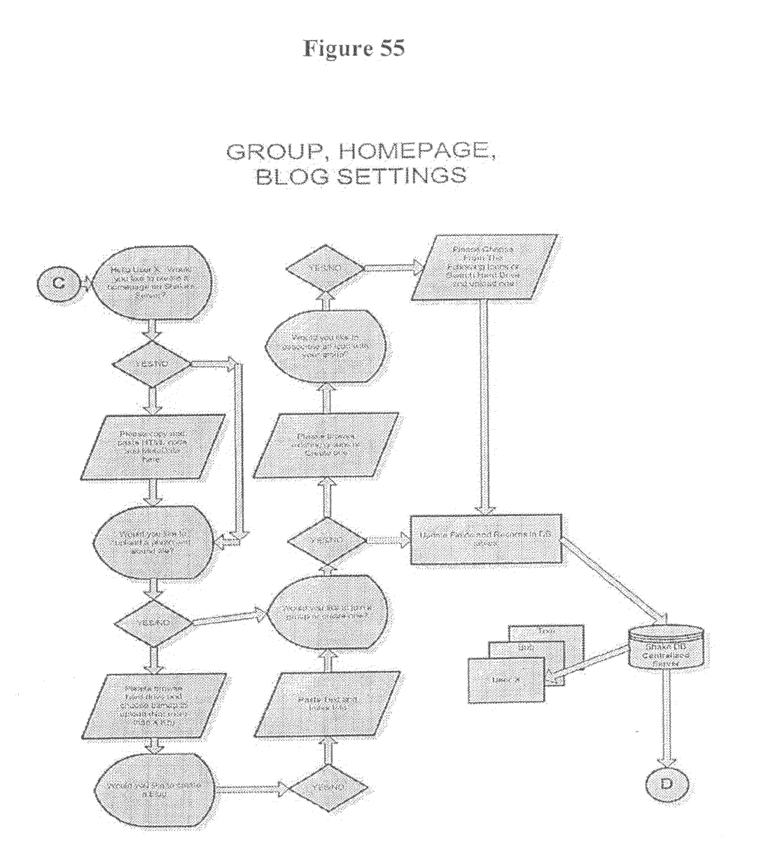

After the database is populated with personal services and fee preferences the user is taken to the GROUP, HOMEPAGE and BLOG setting routine (C) FIG. 55.

### Personalization (Homepage and Blog Settings)

FIG. 55, is a flow chart representing an additional step in creating a profile for the user.

The user in prompted to choose whether he or she wants to create a webpage on the server, if the user chooses to proceed he or she has to paste HTML code and define the metadata for the indexing engine to index the information for retrieval by the search engine from the database.

If the users choose not to proceed, they are forwarded to the media upload routine.

The next step is the media upload routine which asks the user if he or she wants to upload a picture and/or a sound file, in turn, their picture will be represented on the 2D and 3D map with their name under it. If the user chooses to proceed the hard drive browsing routing executes and prompts the user to supply a valid path on his or her local hard drive and upload a known bitmap format (Jpeg, BMP, Tiff, PNG, TGA etc). These can be restricted in size.

If the user chooses not to proceed to the media upload routine they are forwarded to the Blog creation routine.

The Blog creation routine is a recent technology enabling users to create a Web Log=Blog that can be indexed with search engines. If the user chooses to create a Blog then text/HTML and meta data are fields that require users input. Information is then populated in the database.

Next step is the routine of joining a group or creating one from scratch.

If the user chooses to proceed he or she is presented with an option to browse existing groups defined in the database by using an SQL query or utilizing a graphical tree based lists.

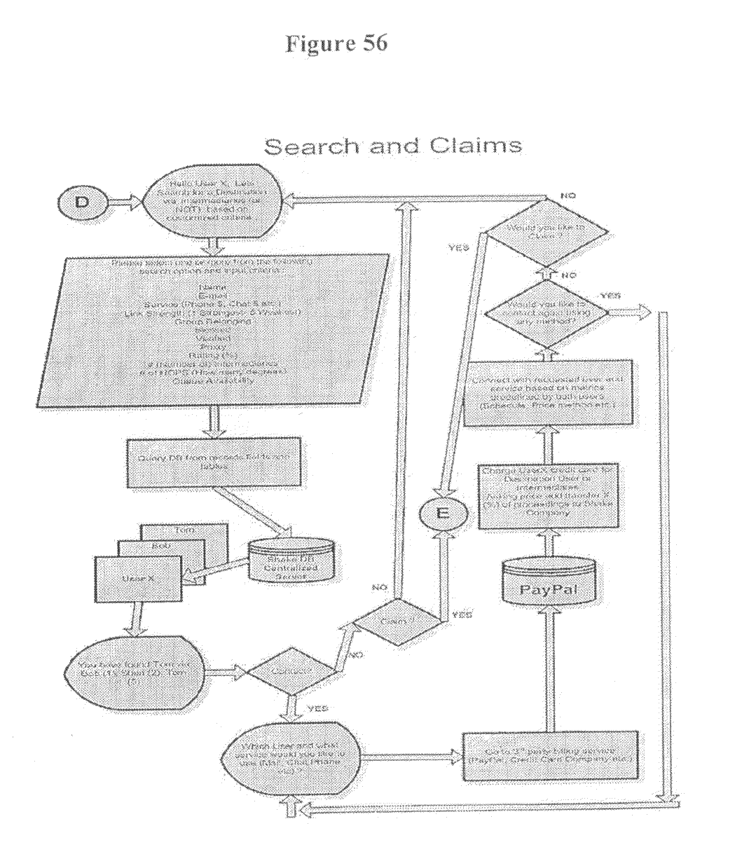

In the next step, If a user decided to create a group from scratch, a routine is executed asking the user to choose an Icon for the group from an existing pool of Icons or browse the local hard drive and upload one to the system. (Any file with the *.ico extension or even bitmap). Next step, The database is populated with new information and the Search and Claims routine is executed (D) FIG. 56.

### Search

In FIG. 56 the user is introduced to a search engine mechanism, In this procedure the user is powered with the ability to search for other users. By default the searching user is considered the “Source” and the individual he or she is seeking is considered the “Destination”. Intermediaries are the people between the source and destination who claim to know at least one person linked to another in the “chain” leading to the destination user. When a user conducts a search which results in querying the database for users relationships, a “Source” user can also be a search point from an intermediary to the destination user.

The user is prompt to input a search criteria (Some of the criteria will be explained in further detail later on) such as: Name, E-Mail, Link strength, Group belonging, blessed, Proxy, Ratings, based on service fee or its availability, number of HOPS (Degrees of separation between the “Source” and “Destination”).

Once the user inputs search criteria into the browser, the client computer contacts the system server which in turn utilizes the search engine to execute an SQL query to the database searching tables, records and fields.

After the database provides results corresponding to the search criteria the user is provided with 2 options:
1. Contact that person
2. Claim that he knows that person and create a relationship type

If the user chooses 1. he is presented with a routine that expects the user to input information in regard to what service is expected to be rendered and paid for after the user was reading the cost associated with contacting the destination user.

Once the user decides to contact that person he is redirected to a 3^{rd} party billing service provider (i.e. PayPal etc) that charges the user and wires a predefines percentage (i.e. 10%) of the transaction proceeds to the system administrator or other operating entity.

The next step is a routine that handles the scheduling of a service be it Chat, Phone, E-mail etc which utilizes a queue and a calendar in order to provide a prompt service.

Once Scheduling and queuing is established and defined the user can contact the destination user.

At the end of the transaction a routine executes asking the user whether he wants to contacts the same user utilizing a different communication method or service. If the user chooses to proceed he is redirected back to the routine that handles the contact method for the destination user.

If the user denies he is redirected to the routine that handles claims.

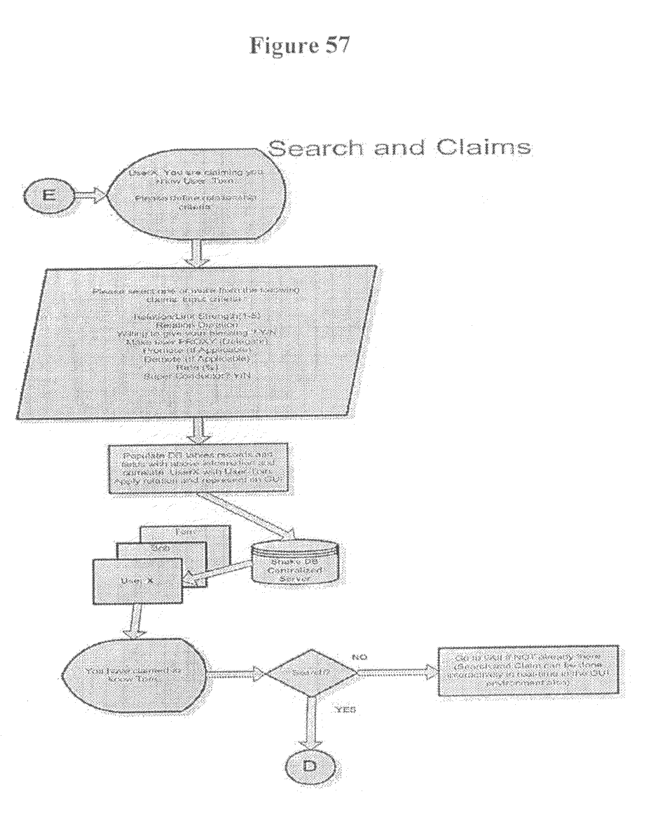

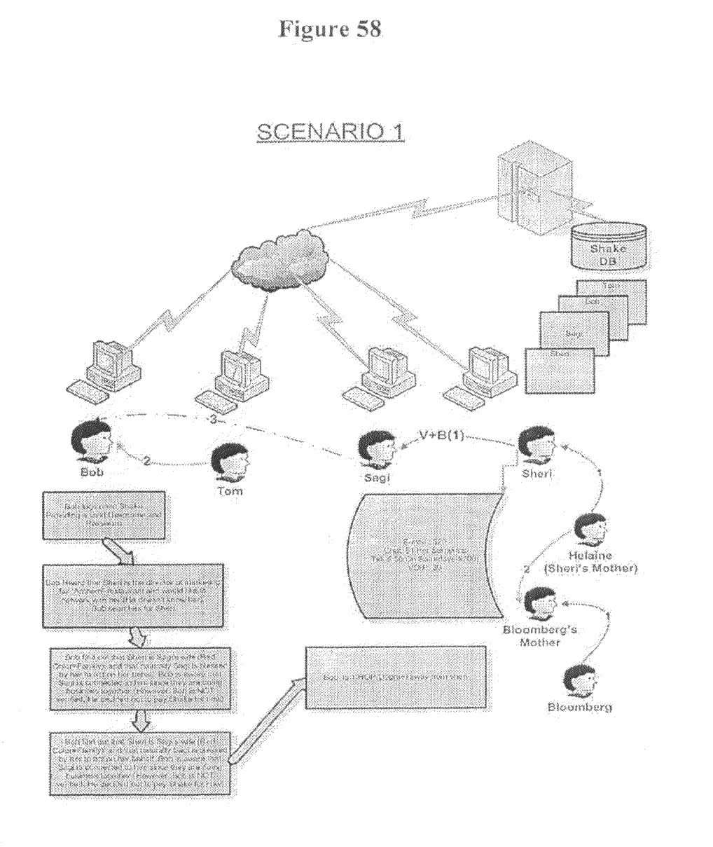

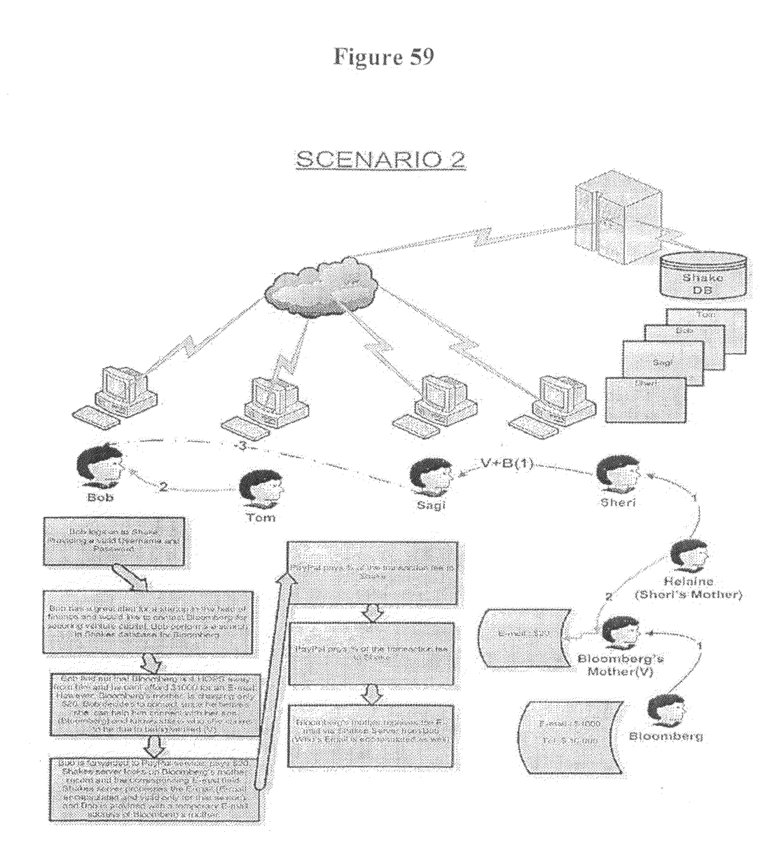

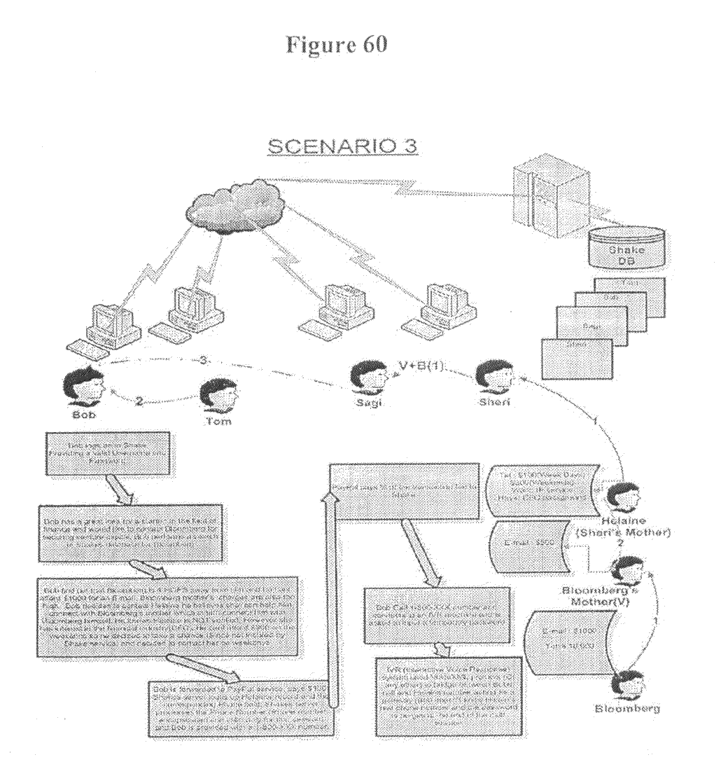

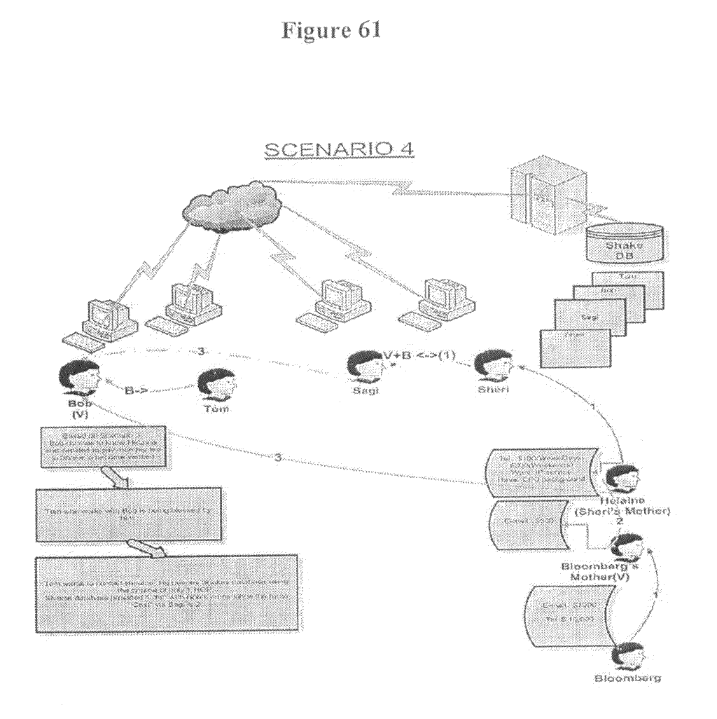

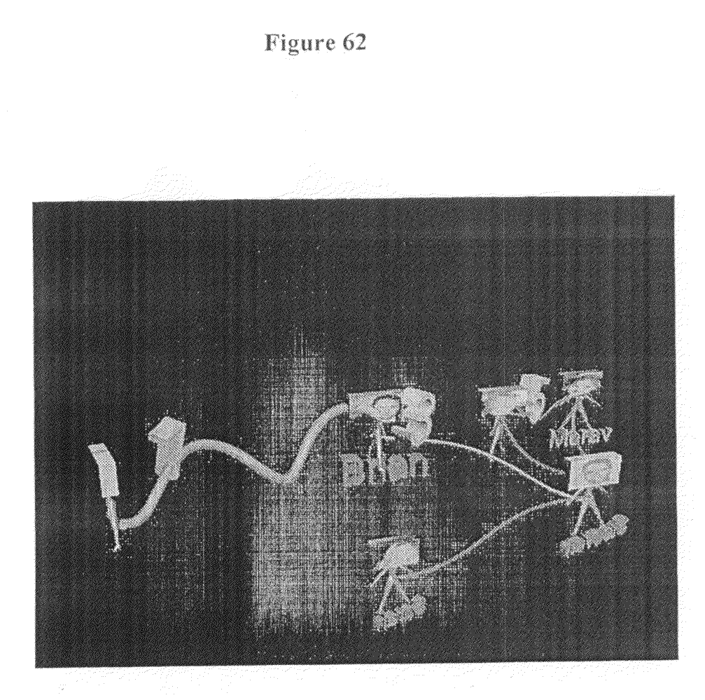

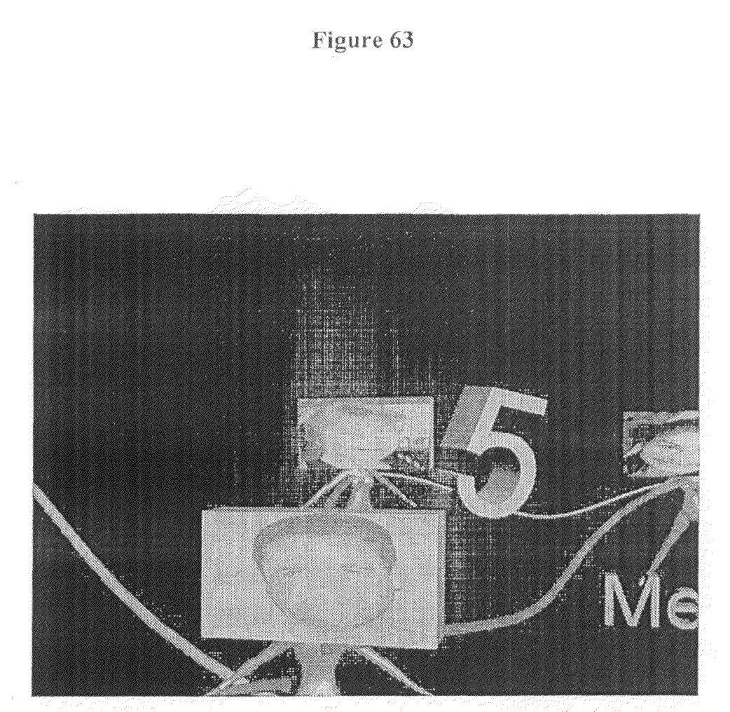

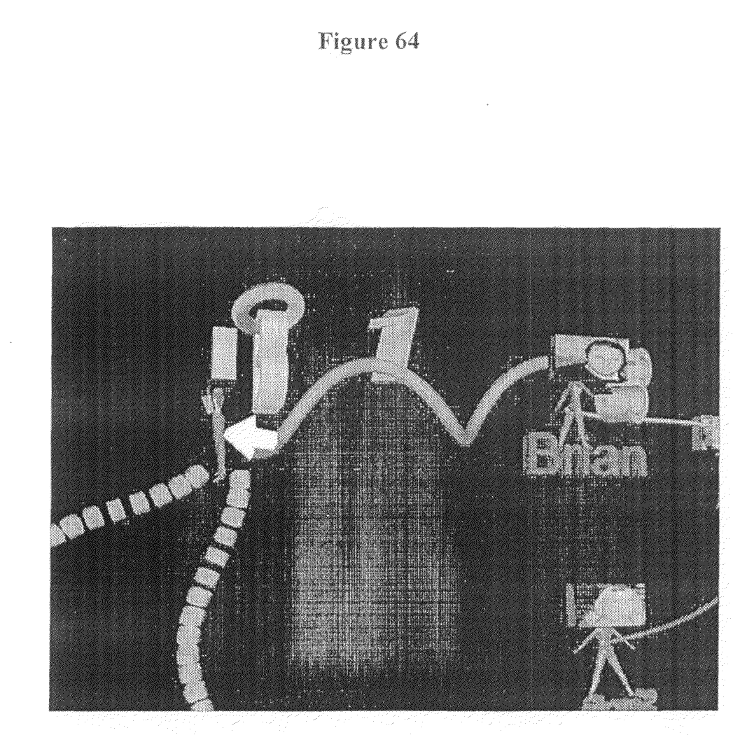

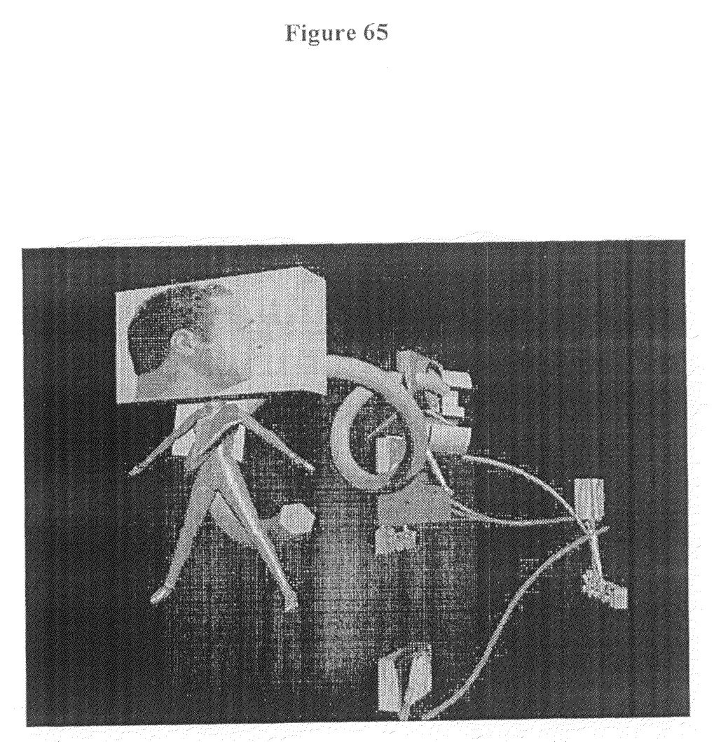

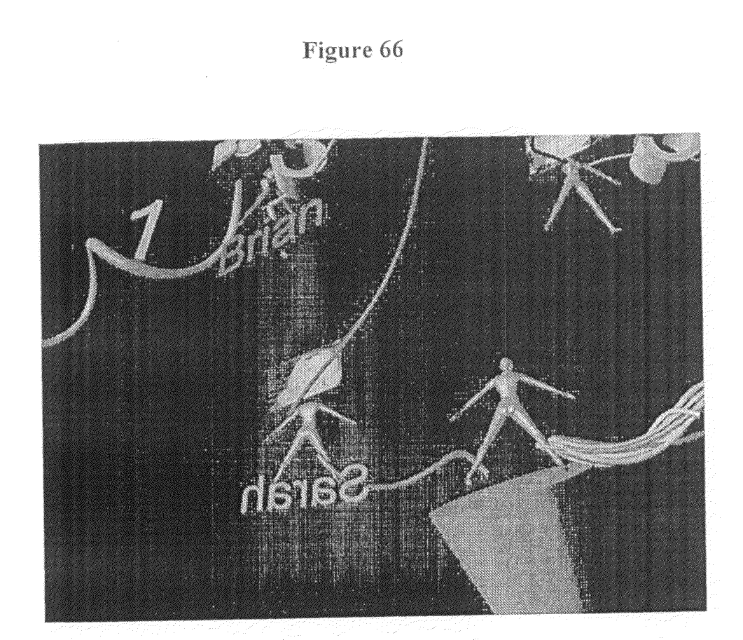

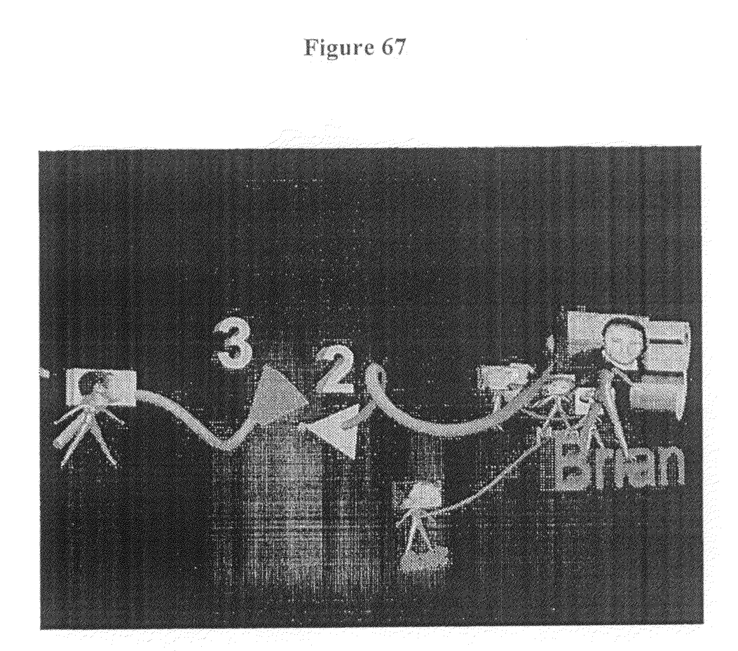

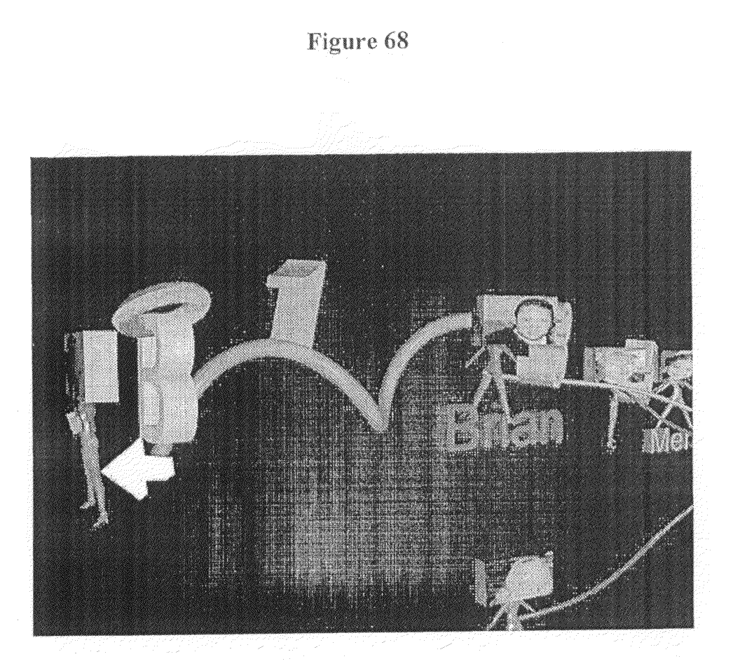

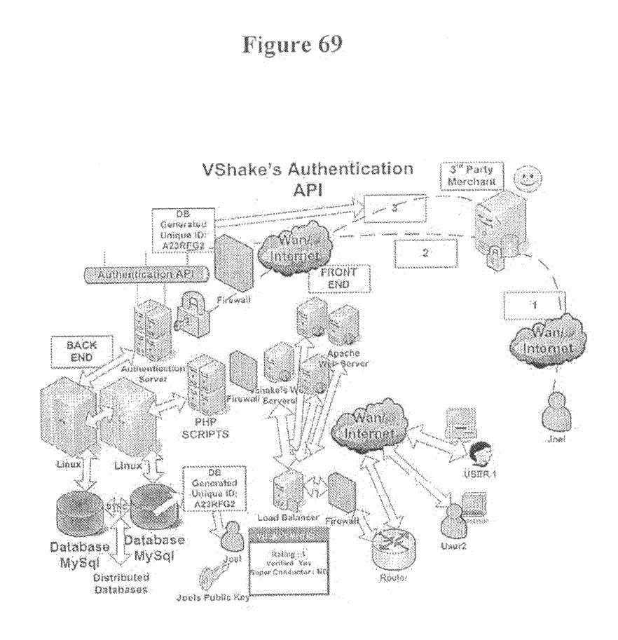

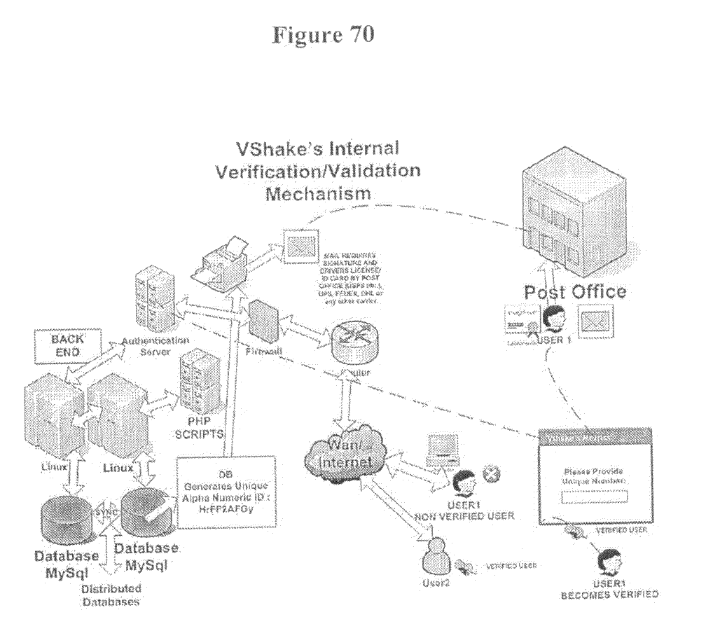

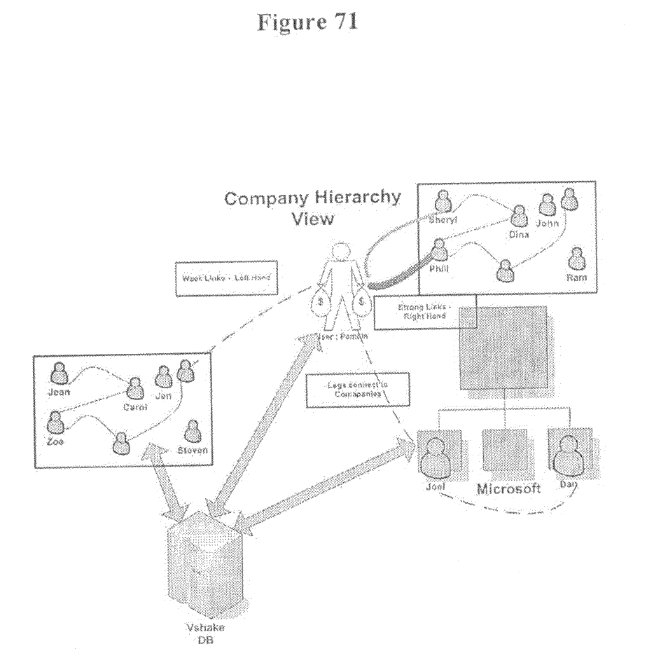

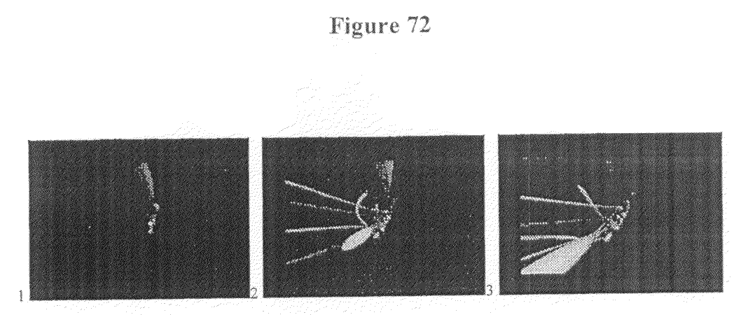

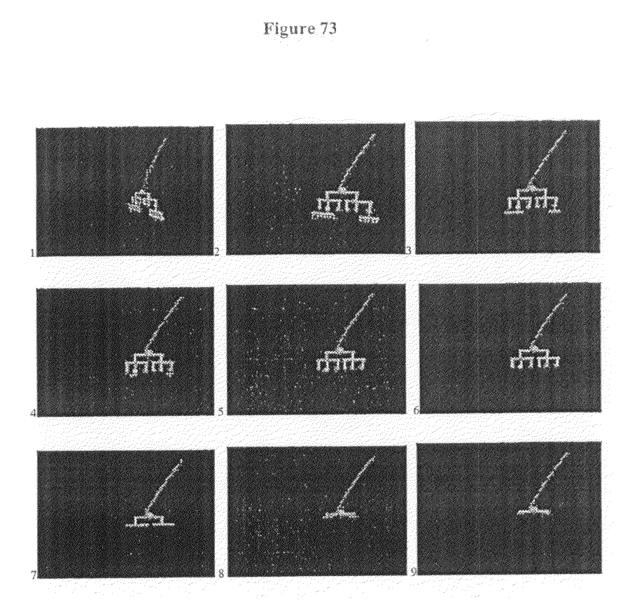

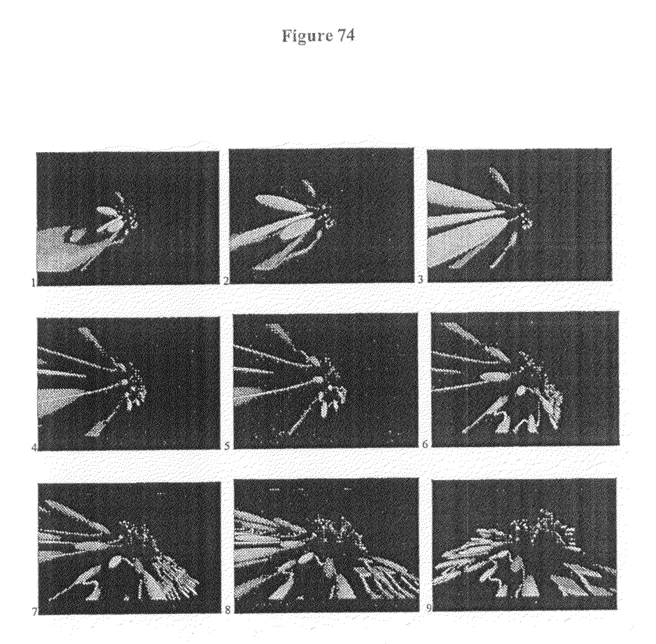

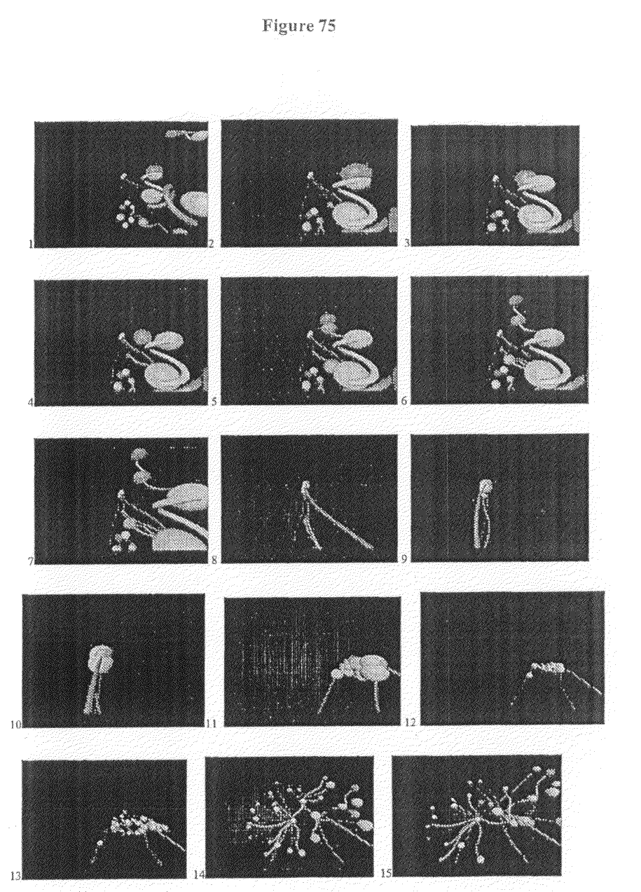

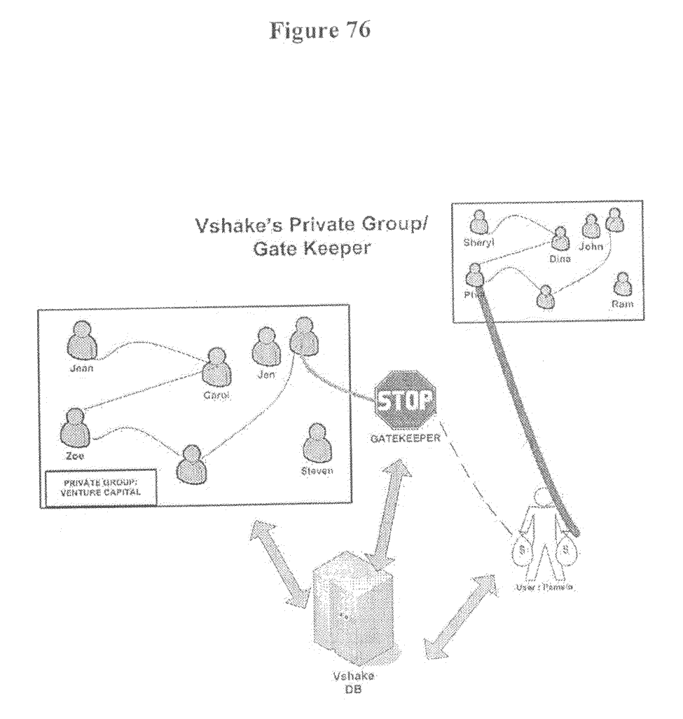

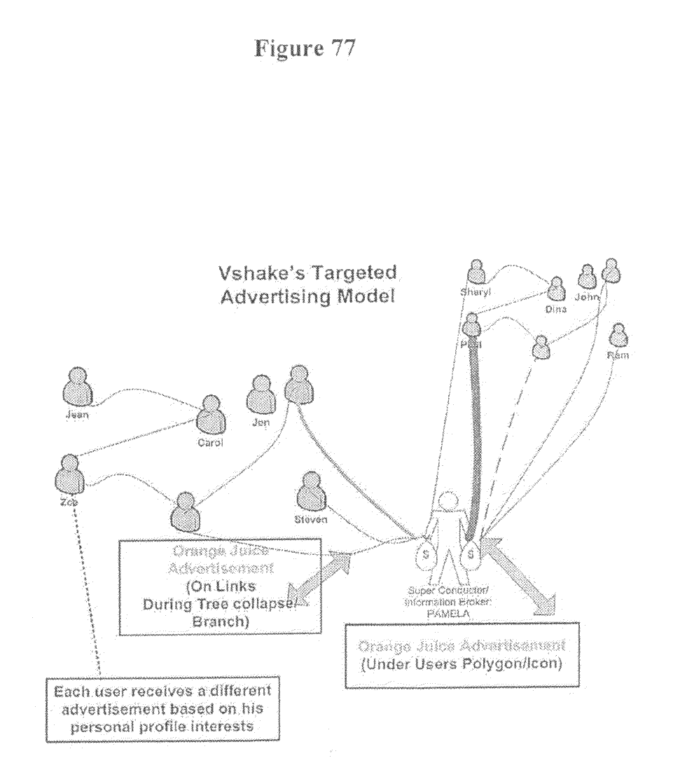

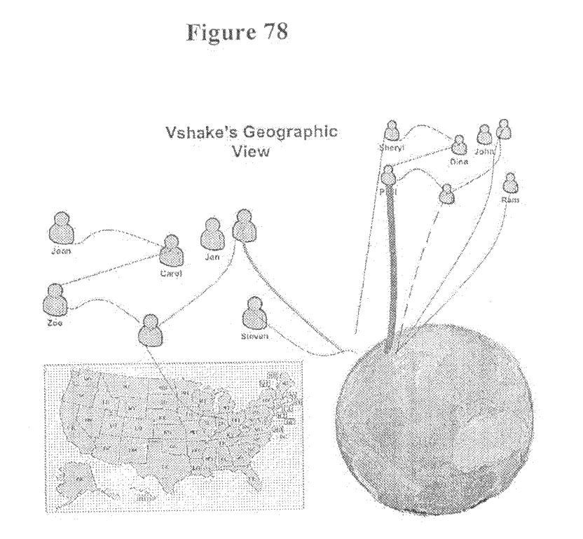

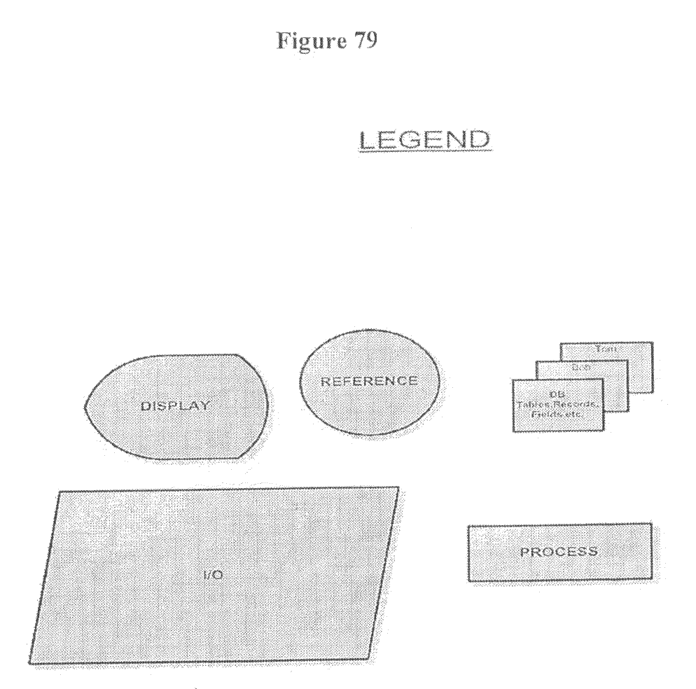

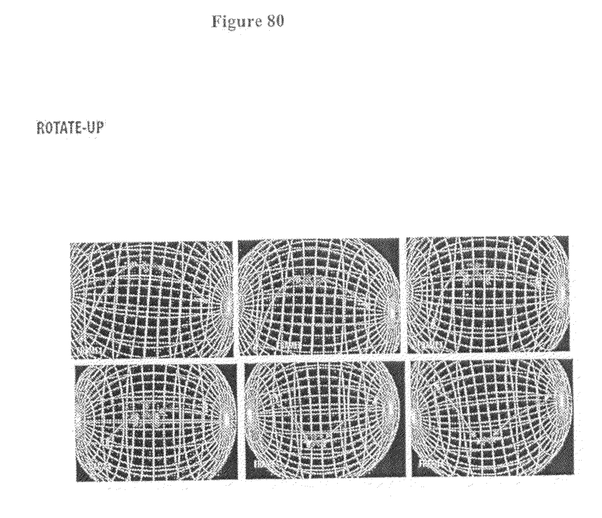

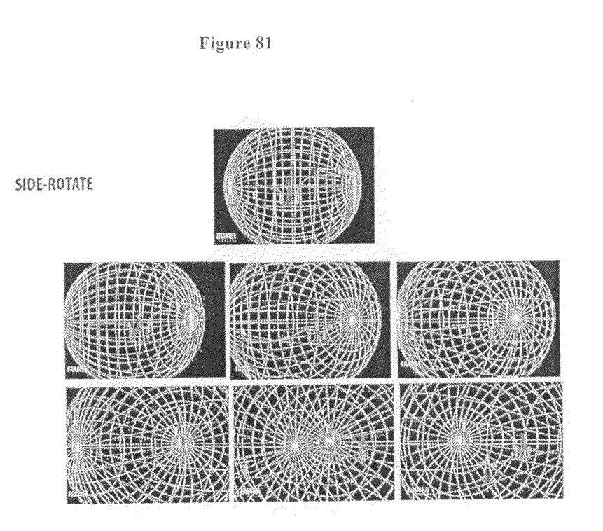

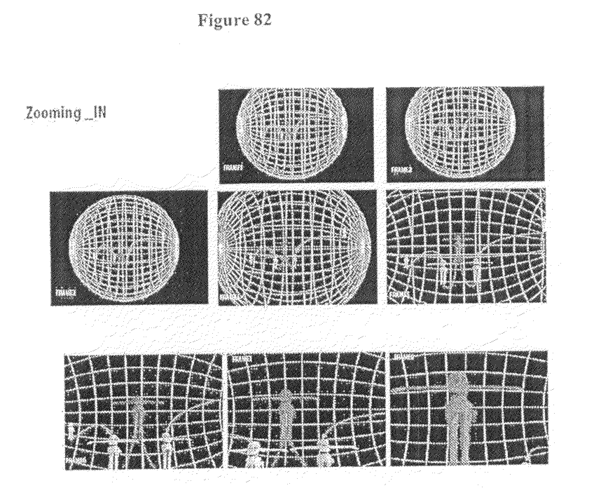

If the user chose option 2 after originally searching the database, he is redirected by the routine to the claims routine (E) FIG. 57

### User Claims (Building the Network)

In FIG. 57(E), after the search routine or after the source user has corrununicated with the destination user, he or she is presented with the option of claiming to know that user or someone else.

It is this procedure and routine that builds the unique relationship based on HOPS (degrees of separation) which is built upon parameter and variables provided to the database in the user's record fields which in turn are used for different metrics.

In this particular case UserX decided to Claim Tom as someone he or she knows and is prompt to define the relationship variables:

Relation Strength (1-5): 1 being strongest (Family ties) and 5 being a casual familiarity
Relation Duration: How long has this relation existed for
Blessing: A parameter used to promote a user to a trusted user by the source user—The ability to communicate on his/hers behalf, so that people using the blessed user services can be absolutely sure he is related to the destination user Only verified users can bless other verified users.

Blessing is a parameter that ensures full insurance on disputed transactions by the system administrator.

Promote (From the destination users point of view)—The ability to set an arrow on the 2D and 3D map indicating what the destination user really thinks this relation strength is
Delete: The ability to delete a relation link: Can only be executed by the original initiator of the claim (Not by a destination user)
Rate: Rate an individual—Another tool used to give feedback about services rendered by a user in order to promote trust in the system
Super Conductor: this parameter is given automatically to individuals who have “TRUE” verified and blessed relationship with a great number (Defined by the operating entity) of other people which are serving as information brokers. This parameter helps user route messages and communicate faster by utilizing a “Super Conductor” person (i.e.: Some one who works for a PR firm or a known celebrity is a good candidate for being a Super Conductor).

After the UserX claimed to know user Tom and provided a variety of parameters discussed above, the database is populated and correlates UserX with User Tom.

The GUI (3D map/2d map) pulls relationship information from the database and presents the links with flexible splines with colors and numbers representing relation strengths.

UserX is notified of knowing user Tom (User Tom is Not notified via any communication device).

UserX is prompt to execute another search (D), if user decided to decline, user is redirected to the 2D/3D map (All claims and searched can be executed in Real Time on the 2D/3D maps, users can drag and drop people on the map and paint a link between users in order to invoke the claim or search routines).

The following is a general description of the mode of operation of the system and method (VShake™) of the present invention:

### Overview

VShake is an online website system that enables individuals to find and connect with other people via 3rd party or intermediates that know the person they are looking for, this system is also known as six degrees of separation and small world theory based on an experiment that was conducted by a Harvard professor in the late 60's that was sending multiple telegrams to the president of the united states via personal friends that were asked to pass along the telegram to whom they see fit just to find out that every single telegram reached the president through about 6 people or less, meaning it was exchanging hands up to six times thus the definition 6 degrees of separation; Me you and everyone else on this 6 billion people planet can be reached via up to six people.

VShake system harnesses the power of the internet in order to connect people instead of using telegrams, the system is only as good as its user base, meaning the more populated the database (more people becoming members of the system), the more critical mass there is, the better chances one has to reach other people.

### Business Model

VShake pushed the envelope a step further by realizing that some of people's personal contacts are hard earned and might take years to develop, that's why we empower our users with the ability to charge other people that are interested in using these contacts.

The innovative side of this business and revenue model is that a person can charge per contact method such as: E-mail, Phone, Fax, Chat etc.

Our motto, is that we are all driven by a need, the psychology behind human nature is that it requires an incentive in order to propel it self forward, and in most cases it is a monetary one, this is why we believe that “time equals money” and one should “put the money where his/her mouth is”, as an example, if you want to contact Bill Gates via one of his vice presidents in Microsoft, you better make sure you have the “right stuff” or in other words most chances are that Bill Gates will charge you a few tens of thousands of dollars to contact him via phone, which only C-level executives can afford and probably provide value added offerings to Bill Gates, if you cannot afford Bill Gates, our system lets you search for people related to him that might do an introduction for a lower fee.

Having said that, VShake's users are not required to charge money for their services and contacts, nor pay a monthly or any fee to VShake at all, this is why VShake system is by default free of charge. We also believe that the notion behind the creation of the internet was to provide free knowledge and an equal opportunity to all, and this is why we leave the choice to our users without “twisting” their arm to whether demand payment for their services, give it for free, pay for becoming verified in VShakes system which will be discussed in greater detail in the following sections, but at the same time have a full functional and unlimited system at their fingertips.

This is why we cater to every person on this planet, be it people stimulated by money or humanitarians, they all gain value from our VShake's system

### Security

Due to our belief that contacts are hard earned we invested a lot time and research into creating innovative security mechanism to ensure the privacy, authenticity, validity of our user base and enhance their online experience in overall, based on this notion we have decided to implement the following security technologies and features:
1. E-Mail: For an e-mail to be sent from one user to another, it has to be stripped from its original address by VShakes proxy (an intermediary) mail server and relayed to the other party (second user) masked as a non real e-mail address, meaning that after the first user paid for the e-mail contact service that was offered by the second user of the system for money he is given a one time generated E-mail address to the second user which he is able to use once. If he decided to send another e-mail without paying a fee again, that e-mail will not reach the second user (The user who offered the service). This prevents people who paid once and decide to bother and take advantage of the service provider (second users). Imagine a scenario where Bill Gates decides to offer his services, say an e-mail address contact for a cost of $10,000, needless to say that only high net worth individuals or people who really believe they have an added value to Bill Gates or vice versa will contact him, once they pay the $10,000 they can only contact him once per payment and ensure that they don't abuse his e-mail address by sending spam or distributing his real E-mail address to marketers and e-mail lists or resell his information. If Bill Gates decides to provide them with his personal E-mail address (out side our system) or phone number that is for him to decide and take a chance.

This system is a natural complement to spam control, individuals can charge 1 cent for every e-mail sent to them. This technology means that the e-mail address provided is only good for that session that was paid for. Advanced features of this service include a calendar option that enables and empowers the service provider to supply convenient time of contact and even charge varying rates for various dates and times
2. Chat: The chat system is very similar to the e-mail system in regard to protecting user's privacy. Current chat system use a nickname in order for a first user to contact a second user, as long as the first user gets hold of this nickname, he or she can abuse the system by sending any text and it requires the second user who is the service provider in our case to attend to the process of blocking the first user which is a waste of their his/her time. We propose a different system where again, the nickname of the second user (provider of the service) is never disclosed, but a “bogus” nickname is generated in real time after the first user agreed to pay for the chat service and is only good for that session; Once any of the parties decide to terminate the chat session, the second user is not accessible any more unless the first user pays again for initiating the chat service. The chat system, similarly to the E-mail mechanism enables the use of a calendar for scheduling of convenient times of interaction and dynamic fees
3. Phone/VOIP: Probably the easiest way to converse in this era is to talk over the phone, that's why we included the option of phone and voice over IP. Either technology requires special attention to security in that we had to ensure again that the real telephone numbers and the IP address is not given to the user requesting and paying for that service. In order to do just that, we created a dedicated server that once again encapsulates (hides/masks) the service provides (second user) real phone number by acting as a proxy. A first user that is interested in contacting the service provider (second user) after paying is given two options:
   POTS (Plain old telephone service)—using the regular house phone, the user calls a 1-800 number after paying and is given a session generated unique code (only good for that session, as long as they both users converse) which he or she is required to provide to our system, and our system on the first users behalf dials to the second user which is the service provider, if any of the parties hang up the phone, the session terminates and any attempts to contact the second user by the first user will fail if he or she tries to provide the same obsolete code to the 1-800 service
   VoIP (Voice Over IP) which is internet based and easy to implement by acting again as a proxy that hides the real IP address of the destination user and works on a proprietary/unique port number.
4. Verification and Authentication: One of the most important procedures and features of our website and added value offerings is to become a verified user. This option requires a user to pay a one time, monthly or annual recurring fee is order to receive a designated verified icon which is presented on the 2D and 3D graphic user interface (to be diLussed later) indicating that this user is genuine. In order to become verified a user needs to supply VShake's company with personal information such as: ID, Social Security Number, Residence etc. VShake goes a step further and contacts the users friends, family, workplace and seeks information from authorities suchas: TRW (Credit Card Information), police, DMV, medical and so forth.

In order to prevent burdening our users with requests and extreme private information such as a Bank account number which is today's preferred verification method by systems and merchants such as Ebay, Paypal etc, we employ a unique and innovative business method and process: Our servers are going to generate a unique number per user requiring verification, instead of asking for his or her bank account number and transferring a small amount of money and asking for the amount number as the password for validation, we are going to send the unique password via regular mail through carriers such as: USPS, Fedex, UPS, DHL etc. and require User Signature (Certified Mail) combined with a requirement to prove and present an ID, this way the user does not need to go to his bank, provide bank account number and reveal personal sensitive information.

VShake company is willing to assist other users in transactions gone bad by acting as an arbitrator between parties due to their verification attribute.
5. Relationship Strength: Beyond providing intelligent decision information for whom to contact, relationship strengths between users are set up and presented by numbers (1=strongest, 5=weakest) and can be unidirectional and bi-directional for identifying truths about a mutual relationship, i.e.: User “A” claims to know user “B” by a value of 1 (family tie), and user B claims to know user “A” (bi-directional relationship) by value of 3 (plain friend) we can conclude that there is something odd about this relationship since there is no agreement and synchronization between parties about how they view their relationship. If both parties agree on the same relationship strength and are verified by VShakes system, they become automatically “blessed” (read below for more information about the blessing mechanism)
6. Blessed: An added value feature of our system is the ability of one user to “bless” another, this blessing means that a user testifies to the validity of that second user. In order for a user to be blessed, the blessing person must be verified by VShake (Must be a paying user for verification procedure—see above paragraph). We might require in the future that both parties need to be verified by VShakes system in order to execute the blessing mechanism.

Blessing is another layer of security telling other users that the user(s) in this system and specifically in the respective relationship are more likely to be genuine and provide high value and service to other users of the system.

VShake is willing to consider the possibility of providing a full money back guarantee in case of a fraudulent transaction between a first verified user and a second blessed user.
7. Rating: VShake is implementing a rating mechanism for users to write feedback about users they have been involved in a transaction with. The feedback rating can be given only once after a paid transaction and cannot be altered. First degree of feedbacks (family members giving feedback about one another) are not accepted. People with high feedback score will be charged less commission and/or annual verification fees.
8. Visual Presentation: VShake's verified users are connected in the GUI (graphic user interface: discussed in further detail in next paragraph) by solid lines representing links, unverified users are connected with dotted (broken) lines, this helps a user isolate and identify non verified users whom he might be avoiding when thinking about executing a transaction with.

### Information Visualization

We realized that potentially the whole world will be using our system and that we cannot present 6 billion people's names at the same time on the users screen, also, we saw a need to represent links between users of the system and that these links should have some meaning (Current system use chunks of text, names of people that are separated by commas with no meaning). This is why we invented an intuitive GUI (Graphic User Interface) which basically operates in two modes: 2D or 3D. This GUI enables a user to seek another user visually by seeing a picture, a polygon (3D figure model) or an icon representing that user. We came to a conclusion that relationships have meaning and context thus we decided to represent links and their strengths by:
1. Color: Solid line (link): (Green: levels of regular relationship; Red: Blood relationship=family)
2. Width: Solid line (link): The thicker the line is, the better the relationship
3. Numerical Value (1-5) above link: 1=family 2=Best Friend 3=Friend 4=colleague 5=saw him/her once in your life
4. Arrows (unidirectional or bi-directional): If there is more than one user we need to know who claims to know one another among themselves and at what strength (Numerical Value above the pointing arrow). Arrows are presented at the middle of a link.
5. Dotted line (Not Solid) representing non verified users, which are users who are non paying. Non verified users links posses no color or width

VShake further enhances the user's online experience by introducing the following indicators and feature set:
A. Verification Icon on polygons (model) chest with a V letter in the middle for ease of identifying verified users, a feature which enhances security.
B. Blessed Icon (discussed above) that is represented by a “B” letter with a halo (donut) shape on top of the letter and the B icon resides on the middle of the link above the directional arrow pointing at the respective user to be blessed.
C. Information Broker/Super Conductor Icon and polygon: a user who is very well connected in our system is considered to be a super conductor or what we call: an information broker, in real life we know many of these types: lawyers who help entrepreneurs and open doors to venture capitalists, agents in Hollywood helping actors get jobs from major studios etc. It is important to identify information brokers since it can save a valuable time using this one person's services vs. going via three people in order to achieve the same result.

Information brokers are designated with a stage or multiple hands joined together icon or a halo around them, Information brokers might receive a discount by VShake which will apply to commissions and/or annual verification fee.

Information brokers are also wonderful candidates by our system for implementing an advertising business model, where they “endorse” a product by our system showcasing this specific product above or under their icon or polygon.

The GUI also includes special filters and helpers in order to assist the user with identifying leads, contacts and reducing the amount of overwhelming information on the limited real estate of the screen:
Filters:
   A. View only people who currently have pictures
   B. View polygons/icons only (No Picture=increase CPU performance for rendering purposes)
   C. View only verified people (Increase chance of safer and better transactions)
   D. Blessed View (See only people who are blessed)
   E. Geographical View: Identify people who are geographically close to other users
   F. Degree View: How deep and extended the circle of relationships at any given time be presented on the screen (Assuming each person knows at least about a hundred people which is his first degree, third degree can be overwhelming amount of information to see at any given time on the screen)
   G. Based on contact method (Show only people who offer and charge for E-mail contact)
   H. Based on charge Min/Max (Only present people who charge a minimum or maximum dollar amount for their service)
   I. Information Broker/Super Conductor view: only show information brokers on the screen
   J. Rating view: View people with minimum positive or negative ratings
   K. Company View: View only people who are associated with companies and/or work for a specific company

### Account Creation

In order for people to find one another, one must first set up:
An Account: A user needs sets up an account on the system by providing account information such as: User Name, Password, E-mail, Phone etc.
A Profile: A user should set up a profile that includes parameters such as: Residency, Birth Date, Hobbies, Needs, Offerings, Load a picture (Bitmap), Marital Status, Gender etc.
One of the most important sections of the profile creation is the NEEDS and OFFERINGS as what we call: WANT, GIVE respectively.

The core idea behind our system is that human nature is driven by incentive and most of the time it is a monetary incentive, this is why it is important to set up and define what is it that an individual is interested in getting from the system and what that same individual believes he or she can contribute and/or the added value that they can provide to other users of the system. It is similar to an exchange or trade if you'd like, as an example, I am interested in people who share my passion for 3D animation, model airplane flying, and I can offer programming services and 3D modeling. Now there is much more to gain by other users knowing what I can offer, what I am looking for and creates an equilibrium and a win-win situation for all parties involved in VShakes system.

To be even more specific one would define not only interests but an actual need, as an example: a lawyer would define: WANT: Corporate Law Customers
GIVE: Corporate Law Services for a great price
A Charge Scheme: Though not mandatory, a user should set up charges per contact method, be it e-mail, chat, phone, fax etc. This option can be set up in a later stage in real time using the GUI and navigation system which we will elaborate in the next paragraphs.
Example: User: Sagi Richberg
   Want: Advice on fixing my laptop
   Give: 3D animation, Programming
   Charge:
      E-mail: $30
      Phone: $1000
      Chat: $200
It is important to mention that a user can also set up a charge for a specific service, i.e.:
   Non Disclosure Agreement Template (NDA): $70
It should also be understood that the above charges are not necessarily associated with a specific tangible product or goods, a user can charge a fee just for anyone to contact him or her, we believe most interactions/transactions in our system between users will be based on a need for an introduction to a 3rd party and/or another person.

### Search

Once an account was created, a user can start searching for other people on the system. It should be understood that the system would be more efficient if a profile was created by the user as well, since there is a reason people are using this system, be it job seekers looking to have their resume read by an HR person or to reach internal people in the company they are looking to work for in the future, marketing people seeking warm leads/direct leads to decision makers and c-level executives in corporations, students in schools and academies looking to collaborate with other students and professors, entrepreneurs seeking contacts with venture capital firms, actors seeking representation by agents, directors seeking contacts to studios, people looking for a dating partner and people just looking for friends to name a few. We modeled the search mechanism partly based on the way routers communicate with one another, we define the user who is searching as the SOURCE and the searched individual as the DESTINATION (or target). Since most people share some of the same contacts with other people a mesh of links is created and naturally creates different paths to the same DESTINATION. (As an analogy derived from the real world, a person can reach the city of New York, N.Y. from several distinct interstate roads).

Cities have become hubs due to the many roads leading to them from other city's, this example was influencing our thoughts in regard to INFORMATION BROKERS/SUPER CONDUSCTORS who are very well connected to many other users of the system.

There are two major ways to search and reach a person:
Target Text Search: A user is presented with an HTML page (web page) similar to a search engine such as GOOGLE, YAHOO etc. The user is presented with several fields where he or she can provide and type diverse metrics (options) such as: search by user name, geographical location (where the person lives), interests (flying, gardening etc.), needs, charges, services and degrees of separation to identify a target single user and then reveal all or some of his/her linked people
Target GUI Search: The ability of a user to do a fly by or fly through in the 2D or 3D space, randomly seek users, follow a path (link) and hop (jump) from users to other users will be discussed in further detail in the NAVIGATION/GUI paragraph.
Path Text or GUI Search: This is where the user can perform more intelligent searches such as seeking a DESTINATION USER via another intermediary user, as an example (User Natasha wants to contact Bill Gates):
From User: Steven Richberg
To User Bill Gates
# Number of HOPS (user relays): 3
Only Show strength(s) of: 1 (family relations)
Only show people who offer service of E-mail
Only show people who charge a maximum of $100 (or range)

### Navigation GUI (Graphic User Interface)

A lot of thought and time was invested in the graphic user interface to make it both intuitive and flexible enough to accommodate users from a non technical background to the most demanding super users that need complexity and flexibility.

We have created two types of GUI's:
2D GUI: This GUI is based on a Flash technology that enables a user to search, pay and claim to know other people (claims will be discussed in further detail in the next section). This technology enables users that have no interest in downloading an executable file (firewall, viruses fear etc.) to reach the system via their browser (Flash is implemented by default in most browsers these days), second, it enables users that are on the road traveling to access our web site and conducts every feature as if they were at their own computer (similar to accessing your e-mail account over the web vs. using outlook application) and third, users with very slow machines will benefit from the 2D low requirement features vs. having to posses a powerful graphics card and deal with compatibility issues with 3D acceleration hardware or software such as: OpenGL, Direct 3D etc.
Once a user executes a search, a plethora of option a results appear on the screen. As indicated before, different people's gender (Male, female and child) are represented on the screen with respective body icons. A user can see peoples pictures above the body icon (assuming those users uploaded their own pictures to VShakes system as part of their profile). Users icons representing their body and the attached picture on the top of that icon are connected by splines and/or Bezier curves which are flexible lines that bent as the user moves the two body icons that are connected by that spline. The TARGET user and the users connected to it that were searched by the first user and their respective body icons and pictures can be moved anywhere on the screen. In order to reduce the amount of overwhelming information we implemented a crystal ball or in other words a distortion mechanism based on hyperbolic projection that only reveals the closest links as full blown body icons and pictures, the further the relationship and its links and related body icons and pictures are, the better a chance it gets “compressed” and distorted to the edges of the screen. The solution is based on a tree architecture, where any click on the far compressed link/icon in the edges of the screen makes that icon and picture animate and come into focus to the middle of the screen and then compress its own respective further away links. The main idea of compressing and distorting far away (further) links is to conserve screen real estate and focus on the links, icons and pictures of the important users. Similar to a tree structure, which is based on a trunk, branches, sub branches and leafs as the smallest part of the tree, so is our system. Double clicking a distorted (compressed) link will bring it into focus by EXPANDING IT, and a second double click will COLLAPSE it, compress it and send it to the edges of the screen again. By right clicking a picture a user is presented with a menu and sub menu that provides information such as the related costs in trying to contact a certain user, specific services offered by that user and their associated calendar etc.

Once a user right clicks another users body icon and picture and selects a service from the list offered on the menu that is invoked on the screen, they are relayed to a third party payment service such as PayPal, Visa, MasterCard etc. and are required to pay the amount indicated on the TARGET's user menue, after money is paid to the TARGET user that is offering its services, VShake takes an X commission from the transaction and the SOURCE user can utilize e-mail, chat, phone, fax and whiteboard (depends what service was offered by TARGET user) to communicate with the target user.
3D GUI: The 3D GUI functionality is similar to the 2D GUI, the only differences are that it is a downloadable client and that instead of seeing a flat icon, links and navigating in 2D (X,Y coordinates) being restricted to hyperbolic projections and distortions, the user can now move in 3D (X, Y, Z Cartesian coordinates) that enables him or her to stop at any given time, move individual polygons (3D body figures), expand or collapse them and control the whole “universe”, meaning rotate the whole content of that sphere containing polygon objects (users) in order to reveal more links or users that were overlapping due to overwhelming amount of information which resulted in the covering of polygons and links by one another. A user can also navigate and “fly” thought and follow link and paths not only in 2 direction (X,Y) but 3 (added Z=depth).
In both GUI modes, users icons and polygons are connected to weak links by their left arm, strong links by their right arm/hand and by their legs to corporations/companies.
A company acts similar to the tree structure we discussed before, since it is hierarchical in nature, thus is expandable, i.e.: at the top is the CEO (Trunk) and under him are senior vice presidents (branch), under them are VP's (sub branch) and below them are Directors, Managers etc. This adds more depth in searching and identifying people in our system.
Above users polygons and icons as user will find icons with different pictures (bitmaps) representing groups, groups are a special interest members who have come together to share this interest. The original creator of the group chooses and uploads the icon representing that group, this adds another layer of depth to our system since a user that is navigating the 2D or 3D GUI can now identify people with the same interest just by looking at their group membership icons.
If people belong to many groups that cannot all be represented at the same time, they will appear as an arc shape above the users body polygon/icon (Between two of the spread arms) and two arrows pointing up and down will be used to scroll between group icons.

### User Claims

One of the most import building blocks of our system are claims. Claims are the process of building the mesh and web of relationships which are in turn translated into graphical links and contacts by claiming to know other users. The claim process can be executed and registration time and visually on the 2D or 3D map.

There are two ways to set up a relationship in VShake:
1. After a user conducts a search and identifies an already existing person in VShakes system he believes he or she knows, he or she can use the text box to enter parameters such as: Relationship strength and bless (Assuming the source user is verified), or right click a users 2D/3D body icon and one of the options on the'menu is “Claim”/“Blessing” and then provide relationship strength, or drag and paint a spline between the user claiming and the TARGET user which invokes a menue asking for relationship strength etc.
2. A user with an account in VShakes system claiming to know a person who is a non member (does not have an account with VShake), in this case a user is created in VShakes systems database (after user provides user name etc. for that new user) but is “greyed out” (disabled) until the real TARGET per son created an account.
A verified user in VShakes system has the right to cut (represented by scissors icon) a link that was claimed by someone else, that original user who initiated the after mentioned is never allowed to claim to know that user again (Unless a private request is given to VShake by the TARGET user)

Variations, modifications, and other implementations of what is described here will occur to those of ordinary skill in the art without departing from the spirit and scope of the invention as claimed. It should also be appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It will be appreciated by persons skilled in the art that the present invention is not limited by what has been particularly shown and described hereinabove. Rather the scope of the present invention is defined only by the claims that follow:

We claim:

1. A system for connecting two or more users, the system comprising:
a host server;
a database module in communication with the host server;
a communication device associated with a first system user;
a network for communication between the communication device and the host server;
wherein the database module stores a contact list associated with the system user, the contact list comprising at least one destination user and a per destination charge associated with each destination user.

2. The system of claim 1, the contact list further comprising a plurality of contact media by which the system user can place other users in contact with the destination users.

3. The system of claim 2, wherein a per-use fee is associated with each contact medium.

4. The system of claim 1 wherein a source user contacts the destination user via a specific contact medium provided by the first system user, and wherein the source user pays a destination charge.

5. The system of claim 4 wherein the source user employs the specific contact medium for a single session.

6. The system of claim 5 wherein a session key is associated with the single session to provide secure communication between the second system user and the destination user.

7. The system of claim 4 wherein communication between the source user and the destination user is routed through the host server.

8. The system of claim 1, wherein the communication device comprises a graphical user interface.

9. The system of claim 1, wherein a graphical network of a plurality of system users and their contacts is presented in least three dimensions.

10. The system of claim 9 wherein the graphical network is represented as a hyperbolic image.

11. The system of claim 9 wherein the graphical network connects users in the graphical network via one or more links, wherein the links provide information concerning a strength of association between the users.

12. The system of claim 1, further comprising a search module and an evaluation module, wherein the search module is employed by a second user to search contact lists provided by a plurality of users, and the evaluation module is used to evaluate available contact paths (e.g., networking paths) by which the second user can reach a destination user.

13. A method of connecting individuals and groups directly utilizing peer to peer and/or client server technology and enabling users to set a price for each contact method and collaboration tool by which such connections take place.

14. The method of claim 13, wherein communication is processed and routed via a central server to provide secure communications, privacy and anonymity by encapsulating users' information.

15. The method of claim 13 wherein an external interactive voice response system is used to encapsulate real telephone numbers.

16. The method of claim 13, wherein a 3D/2D parabolic navigational interface is used to navigate and increase or minimize the amount of information and links presented to a user.

17. The method of claim 13, wherein a virtual network matrix and grid is created and populated when a new user is added by creating a profile in a database.

18. The method of claim 17, wherein a connection and online presence is only available for a session if paid for by the user.

19. A method for assigning an attribute of “verified” to a user based on physical authentication of one or more attributes selected from the group of address, telephone, company, credit card, D&B database record.

20. The method of claim 8, wherein an additional attribute of “blessed” may be assigned to a verified or non-verified user by only another verified user, thus enabling a network of trust and insurance and arbitration by a system administrator/operator.

21. The method of claim 13 further providing a 3D/2D world interface of people links based on spline connections where names, pictures and Icons are used to identify and provide a comprehensive information set in a user friendly format.

22. The method of claim 21, wherein the 3D world-links are be represented based on a geography.

23. The method of claim 21 wherein a user may save the history of one or more links searched for future recall and use.

24. The method of claim 21 wherein users may set up software agents to scavenge for information, users, links, data, objects or services, and provide notification when a result is obtained.

25. The method of claim 21 wherein a user may determine visually which other users are obtaining information about the user or using the user as an intermediate path to another user.
